(19) United States
(12) Patent Application Publication
(10) Pub. No.: US 2013/0337132 A1
(43) Pub. Date: Dec. 19, 2013

(54) LIQUID HEATING APPARATUS

(71) Applicants: Iain Fenna, Peel (GB); Vincent Joseph Garvey, Colby (GB); James Howitt, Colby (GB); Jonathan Michael White, Laxey (GB)

(72) Inventors: Iain Fenna, Peel (GB); Vincent Joseph Garvey, Colby (GB); James Howitt, Colby (GB); Jonathan Michael White, Laxey (GB)

(73) Assignee: Strix Limited, Ronaldsway, Isle of Man (GB)

(21) Appl. No.: 13/978,683

(22) PCT Filed: Jan. 6, 2012
(86) PCT No.: PCT/GB12/50027

§ 371 Date: Sep. 4, 2013

(30) Foreign Application Priority Data
Jan. 6, 2011 (GB) 1100158.3
Jan. 6, 2011 (GB) 1100159.1
Jun. 20, 2011 (GB) 1110375.1

(51) Int. Cl. A47J 31/00

(52) U.S. Cl. CPC A47J 31/002
USPC 426/433; 99/282

(57) ABSTRACT

An infusion beverage making apparatus (100) comprises a liquid heater, an infuser (140) for receiving beverage solid and conveying means for conveying heated liquid from the liquid heater onto the beverage solids. The apparatus (100) is configured to operate in at least one phase in which heated liquid is passed from the liquid heater through the beverage solids and in another phase in which steam is passed through at least a portion of the conveying means. A quantity of water is heated to boiling by the liquid heater and a steam pressure allowed to develop as a result which is sufficient to force steam through at least a portion of the conveying means.

This application is entitled to the benefit of, and incorporates by reference essential subject matter disclosed in PCT Application No. PCT/GB2012/050027 filed on Jan. 6, 2012.

### BACKGROUND OF THE INVENTION

1. Technical Field

This invention relates to apparatus for heating liquid to produce hot or boiling water, for example, for use in infusion beverage makers such as coffee machines.

2. Background Information

Traditional coffee machines comprise a large thermal mass made up of a number of different components which are all required to be hot prior to preparing a cup of hot coffee. These components, which generally include a large thermoblock heater, a group head, a group holder (holding the coffee grounds), the coffee bed itself, a cup and any interconnecting piping from the heater to the outlet, may all be cold on start-up. Therefore, if a volume of heated liquid (which could be less than 50 ml for an espresso) is pumped through the machine just after start-up, even if the liquid has been heated to 100° C. initially, a lot of this heat will be lost to the cold components described above. As will be appreciated, this therefore will result in the water being cooled much below the optimum temperature for brewing coffee (which is approximately 93-95° C.).

To avoid these cold start-up problems, a traditional espresso type coffee machine is usually heated for some time prior to use, e.g. 20 minutes, to achieve thermal equilibrium of the components, particularly for the group holder in which the coffee grounds are held, and therefore many of the components described above are at a high temperature before use. In many designs, waste heat from the thermoblock heater, which is maintained at a high temperature and generally contains a large volume of hot water, is used to heat a plate providing a cup heater. As will be appreciated, this is wasteful of energy.

Another problem that the Applicant has appreciated is that typically these types of coffee machines operate in such a way that not all the brewed liquid is ejected after a brewing cycle, with the coffee grounds themselves, and the associated holding chamber and hot water delivery means all retaining some liquid. In the case of a small brew volume, e.g. as required for an espresso, the retained volume of liquid can represent a significant proportion of the prepared beverage volume. Even for appliances in which the grounds are pre-compacted and then held in a confined arrangement during the brewing process, this problem is still evident. All these features are also wasteful.

### SUMMARY OF THE DISCLOSURE

When viewed from a first aspect the invention provides an infusion beverage making apparatus comprising a liquid heater, means for receiving beverage solids and conveying means for conveying heated liquid from the liquid heater onto the beverage solids, wherein the apparatus is configured to operate in at least a first phase in which steam is passed through at least a portion of the conveying means and a second phase in which heated liquid is passed from the liquid heater through the beverage solids.

When viewed from a second aspect the invention provides a method of operating an infusion beverage maker comprising a liquid heater, means for receiving beverage solids and conveying means for passing heated liquid from the liquid heater onto the beverage solids, the method comprising: passing steam through at least a portion of the conveying means in a first phase; and passing heated liquid from the liquid heater through the beverage solids in a second phase.

It will be seen by those skilled in the art that in accordance with the invention a liquid such as water can be heated to a high temperature in order to produce steam that is passed through part of the apparatus downstream of the heating means, namely the conveying means, following which liquid is heated by the heater and passed through the apparatus to the beverage solids to produce a beverage. This sequence of operation, for example in a coffee machine, allows the components of the apparatus through which the heated liquid will flow—i.e. the conveying means but typically also the means for receiving beverage solids and outlet components downstream thereof to be heated by the steam that is passed through the apparatus. This brings them up to an operating temperature such that hot liquid, when dispensed from the apparatus, will not be excessively cooled when passing through these components.

This arrangement therefore allows an apparatus which is able to operate with very low or zero standby power, but which also provides the ability to pre-heat the key components, i.e. the ones through which the heated liquid flows, immediately prior to use to mitigate the tendency for the beverage to be produced at a lower temperature than desired. This results in a large energy saving compared to traditional apparatus because a large thermoblock heater as well as the large thermal mass of the other components does not need to be kept hot, or heated up for a long period of time, in between or prior to each heating and dispensing cycle.

The first and second phases of operation of the apparatus are intended, in a preferred set of embodiments, to be distinct phases, e.g. preferably controlled by a control means. Therefore the first phase will predominantly produce steam and the second phase will predominantly produce water, but it may be that some water is also produced in the first phase of operation, i.e. passed through a portion of the conveying means, or that some steam is produced in the second phase of operation, i.e. passed from the liquid heater through the beverage solids.

A separate steam generator could be provided for producing the steam in the first phase. Preferably however the liquid heater is configured so as to be operable to produce steam or heated liquid depending on how it is operated, thereby minimizing the number of heaters required.

As well as pre-heating the conveying means and other components downstream of the heater, the steam also provides the advantageous function of displacing residual liquid in the apparatus downstream of the heating means which remains from the previous cycle of operation, e.g. in any connecting piping or a beverage brewing chamber such as a coffee holder where provided.

However, the Applicant has realized that this function could also be performed as a separate step in the same cycle of operation and therefore in a preferred set of embodiments the apparatus is operable in a third phase in which steam is passed through at least a portion of the conveying means after the second phase. This further amount of steam passed through the apparatus can displace any residual liquid and therefore prepare the apparatus for its next cycle of operation. Purging the apparatus of liquid at the end of the cycle is beneficial as it allows the steam to be used to maximum effect at the beginning of the next cycle for pre-heating. The amount of steam passed through the apparatus in this third phase need not be as large a volume as during the first phase, it only needs to be sufficient to displace the residual liquid.

Therefore it will be appreciated that the apparatus can be configured to pass heated water and steam through the apparatus in a variety of different phases. This is considered to be novel and inventive in its own right and therefore when viewed from a further aspect the invention provides an infusion beverage making apparatus comprising a liquid heater, means for receiving beverage solids and conveying means for conveying heated liquid from the liquid heater onto the beverage solids, wherein the apparatus is configured to operate in at least one phase in which heated liquid is passed from the liquid heater through the beverage solids and in another phase in which steam is passed through at least a portion of the conveying means.

The invention also provides a method of operating an infusion beverage maker comprising a liquid heater, means for receiving beverage solids and conveying means for passing heated liquid from the liquid heater onto the beverage solids, the method comprising: passing heated liquid from the liquid heater through the beverage solids in one phase; and passing steam through at least a portion of the conveying means in another phase. As previously mentioned the phases are preferably distinct.

In one set of embodiments, the apparatus is configured to pass heated liquid from the liquid heater through the beverage solids prior to passing steam through at least a portion of the conveying means, i.e. the method step of passing heated liquid through the apparatus is carried out prior to passing steam through the apparatus. This contrasts with the first and second aspects of the invention in which steam is passed through the apparatus prior to the heated water.

Furthermore, in one set of embodiments the apparatus is not configured to pass steam through at least a portion of the conveying means prior to passing heated liquid from the liquid heater through the beverage solids, i.e. the method comprises not passing steam through at least a portion of the conveying means prior to passing liquid from the liquid heater through the beverage solids.

The steam that is passed through the apparatus (and any associated ejected residual liquid) could pass through the apparatus downstream from the conveying means but not all the way to a dispensing outlet. For example, the steam and any liquid may be diverted, e.g. by means of a diverter valve, to a sump or reservoir, which could be a main reservoir for the liquid prior to its being heated to be dispensed or heated to produce the steam.

In other embodiments, however, the steam and any liquid may be allowed to pass all the way to a dispensing outlet. In one set of embodiments this enables all of the fluidically connected components of the apparatus downstream of the conveying means to be pre-heated prior to dispensing as well. There is a further potential advantage in accordance with a set of embodiments in which the apparatus is arranged to dispense at least some of the steam into a user's receptacle. The advantage of this is that it can be used to warm the receptacle prior to dispensing. A drip tray could be provided to catch any residual liquid ejected from the dispensing outlet. In another set of embodiments, alternatively or in addition, this enables all of the fluidically connected components of the apparatus downstream of the conveying means to be purged with steam after dispensing. This may have the function of cleaning (even sterilizing), and potentially drying, the components after a liquid dispensing phase.

The Applicant has recognized that instead of, or as well as, pre-heating the apparatus by passing steam through the conveying means prior to passing heated liquid through the beverage solids, it may be desirable to pre-wet the beverage solids in advance of a main beverage dispensing phase. Thus, in at least one set of embodiments, the apparatus is configured to convey a first (e.g. relatively small) volume of heated liquid from the heater to the beverage solids and then, after a predetermined delay, to convey a second, greater, volume of heated liquid to pass through the beverage solids. Such an initial pulse of heated liquid, followed by a pause, allows time for the beverage solids e.g. coffee grounds to be wetted evenly, and may allow the solid mass to expand, as the small volume of liquid is absorbed and held by surface tension rather than draining away. When heated liquid is then conveyed, preferably continuously, to the beverage solids in a main phase of operation following the delay, the infusion process is improved as the beverage solids are already moist and flavor can be extracted evenly throughout the mass.

During a main phase of operation in which heated liquid is passed through the beverage solids, the pressure in the infusion means that receives the beverage solids may be found to increase (even if the apparatus is vented to atmosphere) as the force of the heated liquid compacts the solids and the temperature of the air space above and/or around the solids increases. Any steam conveyed together with the heated liquid may also contribute to an elevated pressure. As the beverage solids become thoroughly soaked they will tend to clump together into a dense mass with an increased flow resistance. Following a phase of dispensing heated liquid, it can be desirable to release this pressure build-up. It is therefore preferred that in later phase the apparatus is configured to pass steam through the conveying means to the beverage solids. It has been appreciated that such a steam purge phase can advantageously act to drive out any remaining liquid and dry out the beverage solids, thereby reducing the density of the solid mass and relieving the pressure build-up. As described above, passing steam through the conveying means and components downstream thereof can also have a cleaning effect.

In some embodiments a steam purge phase may be provided intermittently between phases of dispensing heated liquid through a given mass of beverage solids. However, it is preferable that the steam purge phase takes place after all of the heated liquid desired for infusion of a given charge of beverage solids has been dispensed, i.e. at the end of a complete infusion cycle. The provision of an initial wetting phase prior to a main infusion phase and a final steam purge phase is considered novel and inventive in its own right. Therefore when viewed from a further aspect the invention provides an infusion beverage making apparatus comprising a liquid heater, infusion means for receiving beverage solids and allowing an infused beverage to be obtained therefrom, and conveying means comprising a pump for conveying liquid through the heater and to the beverage solids, wherein the apparatus is configured to operate in a first phase in which a first volume V₁ of heated liquid is pumped from the liquid heater to the infusion means, followed by a second phase in which the pump is deactivated for a period of time, subsequently in a third phase in which a second, greater, volume V₂>V₁ of heated liquid is pumped from the liquid heater to the infusion means and through the beverage solids to obtain an infused beverage, and subsequently in a final phase in which steam is passed into the infusion means to contact the beverage solids therein.

It will be understood that an advantage of operating an infusion beverage maker in accordance with this aspect of the invention is that the first “wetting” phase and second “pause” phase allow the beverage solids to be primed before the third “infusion” phase takes place, and then the final “steam purge” phase helps to reduce the pressure in the infusion means e.g. so it can be easier to remove the infusion means at the end of a cycle to empty out the beverage solids and re-load. These distinct phases of operation can be beneficial in terms of controlling the density of the beverage solids and their flow resistance, which have an effect on the pressure in the infusion means. The first “wetting” phase may be preceded by a steam pre-heating phase of the kind discussed above. It will be appreciated that the pump is preferably a mechanical pump rather than a thermal pump, so as to enable ease of control in the different phases. The pump may be activated for at least part of the final phase in which steam is passed into the infusion means. Or the pump may be deactivated after the third “infusion” phase so that steam is conveyed from the heater substantially under its own pressure.

In one set of embodiments according to any of the aspects of the invention, a quantity of water is heated to boiling by the liquid heater and a steam pressure allowed to develop as a result which is sufficient to force steam through the conveying means. Such steam pressure may be used to provide a final “steam purge” phase as described above. A particularly advantageous arrangement for creating such a steam pressure will be described in more detail below.

The liquid heater could comprise any type of heater, e.g. an immersed or underfloor heater with an associated heating chamber. However in a preferred set of embodiments the liquid heater comprises a flow heater, e.g. of the type disclosed in WO 2010/106349 or WO 2011/077135. A flow heater typically has a much lower thermal mass than a traditional coffee maker with its large thermoblock heater, and is suitable for producing both heated water and steam. The low thermal mass of a flow heater aids having a very low or zero standby power, as well as a very short start-up time, i.e. the time taken for the components to be heated up by the steam passing through the apparatus before liquid dispensing can commence.

In one set of embodiments the heater comprises a final heating region having a space above the liquid surface for allowing the escape of steam from the liquid surface. Preferably the final heating region is arranged to permit the exit of steam therefrom separately from heated water. In a preferred set of embodiments the heater further comprises a heated flow conduit upstream of the above-mentioned heating region and which is arranged in use to be filled with water, as is disclosed in WO 2010/106349.

Providing a final heating region which allows steam to escape separately from the heated water enables both heated water and steam to be produced from a single heating component. This is particularly advantageous when the heater further comprises a heated flow conduit upstream of the heating region as it overcomes the difficulties of producing steam using a conventional flow heater, e.g. spitting and overheating from localized boiling.

It will be seen that by providing a flow heater with a final heating region which allows steam to escape from the surface of the liquid without forcing the heated liquid out, the phenomenon of spitting is reduced or avoided. Moreover the facility for steam to escape allows the heated surface of the heater to remain flooded in liquid and so avoid localized hot spots. Thus, in accordance with preferred embodiments of the present invention this arrangement can be operated to either produce steam or heated liquid, e.g. by controlling the flow rate of liquid through the heater.

A standard flow heater can be thought of as one in which there exists in use a temperature gradient along the direction of flow. Whilst the invention allows heated liquid to be produced, only the liquid in the final heating region achieves the final temperature; it is not necessary to heat the whole of the contents of the heater to that temperature as would be the case with a ‘batch’ heater, e.g. the aforementioned coffee maker thermoblock heater. For example a cold water temperature of 20° C. preheated to 80° C. in the first region will have an average temperature of only 50° C.

In accordance with some embodiments of the invention a final heating region continues to heat water from the temperature at which it leaves the heated flow conduit (e.g. resembling a traditional flow heater), to a higher temperature, which could be boiling, depending on in which stage of the cycle of operation the apparatus is running. A separate heating element could be provided for this purpose. In a set of preferred embodiments however a single heating element is provided which extends from the heated flow conduit into the final heating region.

In a preferred set of embodiments in which the liquid heater comprises a flow heater with a final heating region, preferably arranged to heat liquid to boiling, the space above the liquid surface may be provided by a closed chamber, rather than a chamber that is open to the atmosphere. The closed chamber does not allow steam to exit except through the outlet of the heater. As steam is generated in the final heating region and expands in the space provided by the closed chamber, the pressure increases. While the space in the chamber allows for physical separation of steam from the liquid heated in this final region, the steam pressure that is created by the closed chamber has the benefit of forcing liquid (and some of the steam) out of the heater even after liquid is no longer flowing into the heater. This helps to ensure that the heater is completely emptied. Once all the liquid remaining at the end of a heating phase has been forced out of the heater or evaporated, the pressurized steam in the closed chamber then moves under its own pressure out of the heater and through the conveying means to the beverage solids. The closed chamber and steam pressurization therefore provides for a natural “steam purge” phase after the heated liquid has been dispensed.

In a particularly preferred set of embodiments the apparatus comprises an infusion means for receiving beverage solids and allowing an infused beverage to be obtained therefrom, and means for conveying liquid through the heater and to the infusion means, wherein the heater is a flow heater comprising a final heating region provided in a closed chamber with an expansion space for steam above the liquid surface. Preferably the heater is turned off at the end of a phase of conveying heated liquid to the infusion means, and the steam pressure developed in the closed chamber then acts to drive any remaining liquid and/or steam out of the heater.

A further advantage of the final heating region of the heater comprising a closed chamber with an expansion space is that bubbles of steam produced irregularly in the heated liquid upstream of the final heating region can move into this air space rather than collecting in the flow heater and potentially forming an interference layer on the heater element that can result in local overheating. This helps to avoid hot spots which would otherwise result in flash boiling and spurts of steam interrupting a smooth flow of heated liquid. In at least some embodiments the closed chamber comprises an outlet means arranged such that a minimum volume of liquid is retained in contact with the heater and its heating element. The outlet means may, for example, comprise an outlet tube arranged at or above the normal water level during operation of the heater. In other embodiments the closed chamber may comprise a weir arranged upstream of an outlet so as to hold back a minimum volume of liquid in the final heating region (as is described in more detail below). Such arrangements ensure that the heater, or rather its heating element, remains covered in liquid during normal operation rather than allowing hot spots to develop.

While an outlet arrangement that holds back a volume of water is beneficial in terms of preventing the heater from boiling dry during normal operation, there can be a problem that after the flow heater has ceased its operation some liquid will be left behind. The closed chamber provides a solution to this problem as the pressurized steam that builds up in the expansion space can then force any remaining liquid out of the outlet in a final purge of the flow heater, leaving it entirely dry.

This is considered novel and inventive in its own right, and thus when viewed from a further aspect the invention provides an infusion beverage making apparatus comprising a liquid flow heater, an infusion means for receiving beverage solids and allowing an infused beverage to be obtained therefrom, and means for conveying liquid through the heater and to the infusion means, wherein the flow heater comprises a final heating region provided in a closed chamber with an expansion space for steam above the liquid surface and an outlet means arranged to limit the exit of liquid and/or steam from the heater, wherein the apparatus is configured to operate in a liquid dispensing phase in which the heater is operated to heat liquid and heated liquid is conveyed to the infusion means while a steam pressure is developed in the closed chamber, and wherein after the end of the liquid dispensing phase the steam pressure in the closed chamber acts to force any liquid remaining in the heater through the outlet means in a final purge phase. As previously mentioned the phases are preferably distinct.

The chamber may be permanently closed, e.g. having a sealed or integral construction, or it may be closed during use by a valve. Such a valve may be provided where it is desired to close the chamber from atmosphere during normal operation but to allow for the escape of steam from the final heating region in the event of an over-pressure being developed, for example due to a blockage downstream. Preferably a one-way valve is provided for such pressure release.

In accordance with all aspects of the invention, the liquid flow could be driven by hydrostatic pressure achieved by arranging a reservoir of liquid above the outlet and using a valve or tap. Preferably, however, a pump is provided for driving liquid through the heating means and conveying means. A pump allows the flow of liquid or steam through the apparatus to be controlled in order to be able to produce steam or heated liquid for passing through the apparatus downstream of the heating means.

A further advantage of pumping liquid and/or steam through the heater and conveying means to the beverage solids (e.g. contained in an infusion means) is that the delivery of heated liquid for infusion of the beverage can be well controlled. In particular, the rate of liquid delivery and/or the time period of liquid delivery can be controlled depending on the amount of beverage solids being infused. The flavor of an infused beverage has been found to depend on the time for which the beverage solids are in contact with heated liquid during which extraction occurs. The strength of a beverage may also depend on the rate of extraction. One way to control the infusion process is to vary the pump speed so as to control the rate at which heated liquid is conveyed into contact with the beverage solids. However, the Applicant has recognized that it may not be desirable to vary the pump speed, at least for this purpose, as it also dictates the flow rate of liquid through the flow heater and hence the liquid temperature attained. The Applicant has recognized that, in practice, it is desirable to use the pump speed to maintain a substantially constant flow rate through the heater and thereby reliably achieve a desired temperature for the liquid passed to the beverage solids. When brewing coffee, for example, it can be desirable to provide liquid heated to a temperature of 92-96° C.

In order to be able to control the rate of liquid delivery for infusion purposes independently of adjusting the heater flow rate and liquid temperature, it is advantageous that the pump speed is preferably not adjusted for this purpose. Instead, the apparatus may comprise a liquid delivery control means downstream of the heater. For example, the conveying means may comprise a valve to control the delivery of heated liquid to an infusion means containing the beverage solids. Although a one-way valve may be used to switch the flow on and off, this risks a back pressure that could interfere with operation of the heater. Rather it is preferred that a two-way valve is provided to either deliver heated liquid to the infusion means or to deliver the liquid to an alternative bypass path. The bypass path may exhaust heated liquid that is unwanted into a sump, for example under a drip tray of the apparatus, that can be emptied periodically, or it may be arranged to recycle the liquid to a reservoir for the apparatus.

However, the Applicant has recognized that a valve arranged to direct heated liquid to a bypass path instead of to the beverage solids can provide another advantageous function. When liquid is pumped through a flow heater at a relatively fixed rate so as to attain a suitable temperature for infusion, e.g. 90° C. or above, this does not allow for different volumes of infused beverage to be obtained without varying the overall infusion time, but an optimum infusion time for a coffee beverage is only a minute or two and over extraction of the flavor can result in a bitter-tasting beverage. This problem can be solved by controlling the valve to deliver heated liquid to the beverage solids for a given infusion period, optimized for the beverage flavor being infused, and then switching the valve to deliver further heated liquid to the infused beverage but bypassing the beverage solids. The additional liquid delivered in the bypass mode can be used to make up the beverage to a desired final volume and/or intensity without compromising the flavor extracted from the beverage solids. Delivery via the bypass path can be controlled depending on the dilution required to achieve a desired flavor intensity.

The valve could be arranged at the outlet of the conveying means to direct the heated liquid to a bypass path around the infusion means. For example, the beverage solids may be contained in an infusion basket with a bypass channel provided outside the basket. Or the valve could be arranged to direct the heated liquid to a bypass path terminating past the infusion means, e.g. directly to a receptacle for the infused beverage. The infused beverage and the heated liquid delivered via the bypass path may be allowed to mix together in the stream exiting the infusion means or inside such a receptacle. However it may be preferred that the mixing is hidden from view. In one embodiment, both the infused liquid and the liquid from the bypass path may be delivered through a common outlet, which may be covered by or formed in the lid of a receptacle for the beverage. In another embodiment the liquid from the bypass path may be delivered directly into a volume of infused beverage, for example contained in a receptacle for the beverage. The bypass path may be terminated by an opaque delivery means so that the addition of liquid to the infused beverage is not readily visible.

As the heated liquid provided by a flow heater may include some steam, especially when there is provided a final heating region, preferably comprising a closed chamber, to enable for the release of steam, the bypass path may contain a water/vapor separator or steam vent to ensure that it is only liquid which exits the bypass path.

It will be appreciated that in embodiments wherein the conveying means comprises a valve to control the delivery of heated liquid either to the infusion means or to an alternative bypass path, preferably there is no concurrent flow of liquid to both the infusion means and the bypass path. Rather, the valve switches the flow between the two delivery paths. This is advantageous as a single common conveying means can be provided to deliver heated liquid from the heater; a dedicated bypass path for hot liquid is preferably not provided. However, the Applicant has recognized that there can be a problem with switching the valve between a phase of delivering heated liquid to the infusion means, and a phase of delivering heated liquid to the bypass path, due to a pressure build-up in the infusion means that can create a back pressure in the conveying means. In order to address this problem, preferably means are provided to release the pressure in the infusion means before switching the valve to provide a bypass flow. This could possibly be achieved by arranging to unseal the infusion means or vent it to atmosphere. However this may require user intervention.

In an advantageous solution the apparatus is arranged to provide an infusion phase followed by a steam purge phase and then to switch the valve to deliver further heated liquid via the bypass path. As is described above, when a steam purge phase follows a liquid heating and dispensing phase, the steam coming into contact with the beverage solids can cause them to dry out and expand with a release of vapor pressure in the infusion means. Following such a steam purge the valve can more easily be switched to provide a bypass flow. This is considered novel and inventive in its own right, and thus when viewed from a further aspect the invention provides an infusion beverage making apparatus comprising a liquid flow heater, an infusion means for receiving beverage solids and allowing an infused beverage to be obtained therefrom, and conveying means comprising a pump to convey liquid through the heater and to the infusion means, and a valve downstream of the heater to control the delivery of liquid to the infusion means, wherein the apparatus is configured to first operate in a liquid dispensing mode in which the heater is operated to heat liquid and heated liquid is pumped into the infusion means, followed by a steam purging mode in which steam is passed into the infusion means to contact the beverage solids therein, and subsequently in a bypass mode in which the valve switches the delivery of liquid to a path bypassing the beverage solids.

As is described above, the bypass path may pass through or around the infusion means, separate from the beverage solids, or the bypass path may deliver heated liquid downstream of the infusion means. Preferably the bypass path delivers heated liquid into the same receptacle that receives infused beverage, so that the bypass flow can be used to dilute the beverage and make up a desired volume. An advantage of providing such a bypass mode is that a relatively large volume of beverage can be produced in a short space of time as compared to beverage makers such as coffee percolators that require all the heated liquid to pass through the beverage solids. According to embodiments of the present invention a 2 L jug of coffee can be prepared in under 10 mins as compared to at least 20 mins using a conventional percolator.

In the steam purging mode the pump may continue to operate, but in preferred embodiments the pump may be deactivated or slowed while a steam pressure in the flow heater drives the steam delivery, as discussed above. The flow heater may therefore comprise a final heating region provided in a closed chamber with an expansion space for steam above the liquid surface and an outlet means arranged to limit the exit of liquid and/or steam from the heater so that a steam pressure is developed during the dispensing mode. The heater may be operated continuously in the different modes, or it may be deactivated during at least part of the steam purging mode. Preferably the flow rate through the heater is kept substantially constant, e.g. by controlling the pump, to maintain a desired liquid temperature substantially constant in the different modes.

The switching of the valve to deliver liquid to the bypass path may be controlled to take place after a certain time has elapsed, empirically determined to correspond to a suitable pressure reduction. Or the switching of the valve may be dynamically controlled in response to sensing the pressure in the infusion means. For example, the valve may be controlled to switch to the bypass mode when the pressure is determined, empirically or directly, to drop below 0.05 bar above atmospheric.

In the liquid dispensing mode the flow heater may operate continuously or it may have a pulsed operation. At least one pulse of heated liquid may be initially delivered into the infusion means, followed by a pause, before further operation of the flow heater to dispense a larger volume of heated liquid. Such a pre-wetting mode of operation has already been described above and any of those features may be provided in embodiments according to this aspect of the invention. Preferably the dispensing mode following a single pre-wetting pulse is continuous so as to minimize the overall beverage infusion time and avoid over extraction of flavor from the beverage solids.

If it is desired to dispense heated liquid independently of an infused beverage then this can be achieved by switching the valve to bypass mode when there is no pressurization from the infusion means. For example, it may be desired to dispense a volume of hot water into a jug for warming purposes before operating the apparatus in the liquid dispensing mode to make an infused beverage. Or it may be desired to dispense heated liquid for use externally of the apparatus.

Any suitable valve may be provided, but an electromechanical e.g. solenoid valve is preferred for robustness and reliability of control. The valve may be controlled by an electronic control unit, for example a microprocessor-based control. A user interface may be provided for a user to input commands. Upon receiving a particular command the microprocessor may run a program that controls the liquid dispensing and bypass modes to produce a desired beverage e.g. in terms of volume and/or strength.

Any suitable pump could be used, but in one set of embodiments the pump comprises a centrifugal pump. These are smaller and quieter than the reciprocating pumps used in some known beverage making devices. In other embodiments a reciprocating pump may be used, for example depending on the pressure at which it is desired to deliver liquid.

In one set of embodiments the centrifugal or reciprocating pump is arranged to deliver a pressure of less than 0.5 bar, e.g. 0.2 bar, above atmospheric. This is a particularly low pressure for coffee machines, but one for which embodiments of the present invention are particularly suited, and therefore does not require the apparatus to be designed to withstand high pressures, e.g. up to 15 bar in some pressurized coffee machines, which can be expensive. This is considered to be novel and inventive in its own right and therefore when viewed from a further aspect the invention provides an infusion beverage making apparatus comprising means for receiving beverage solids and a centrifugal or reciprocating pump for pumping water through the beverage solids, wherein the centrifugal or reciprocating pump is arranged to deliver a pressure of less than 0.5 bar above atmospheric pressure.

In one set of embodiments the power to a centrifugal pump is controlled using pulse-width modulation. This provides a very responsive control over the speed of the pump which leads to smooth changes of speed. In contrast, the average speed of a reciprocating pump can usually only be controlled by turning it intermittently on and off, which can add to the noise of such pumps.

It may be desirable to measure the temperature of the liquid in or exiting from the heater, and therefore in a preferred set of embodiments the apparatus comprises temperature sensing means. This could, for example, be used as part of a feedback control system to control the flow-rate of water passing through the heater, and thereby determine the mode of operation of the apparatus. When heated water is required it is advantageous to be able to exercise control over the flow rate since the optimum flow rate is determined by the precise power of the heater, the performance of any pump provided, the supply voltage and the incoming ambient water temperature. The first two of these factors are subject to manufacturing tolerances whilst the latter two can vary during use.

In one set of embodiments temperature sensing means are provided in the final heating region for determining the output temperature of the liquid. Alternatively or additionally temperature sensing means could be provided in the heated flow conduit.

In one set of preferred embodiments, means are provided for controlling the temperature of liquid supplied by the heater. The Applicant has appreciated that the output temperature of the liquid is a function both of the power of the heater and of the flow rate. Accordingly, either of these two parameters could be varied. In a set of embodiments, the means for controlling the temperature comprises means for altering the flow rate of liquid through the heater. For example, for a typical 3 kilowatt heating element, the Applicant has discovered that water can be supplied at approximately 90° C. (assuming it starts at approximately 17° C.) if the flow rate through the heater is approximately 590 ml per minute. If the flow rate is increased to 1000 ml per minute, the water is supplied at a temperature of approximately 60° C.

In one set of embodiments the final heating region comprises a liquid level sensor. This helps to control the different phases of operation of the apparatus, in particular the steam production phase. By controlling the liquid level in the final heating region, the mode of operation can be changed between steam and heated liquid production. In a set of preferred embodiments means are provided to permit automatic outflow of liquid upon the liquid reaching a predetermined level. By providing a predetermined level at which the liquid flows out of the final heating region, the flow rate of liquid can be controlled to keep either the level of liquid below the predetermined level for steam production, i.e. to encourage boiling of the water, or the flow rate can be controlled to raise the liquid level above the predetermined level and therefore allow heated liquid to flow out of the final heating region and to the conveying means.

Providing means to permit automatic outflow of liquid upon the liquid reaching a predetermined level ensures that, particularly in the phase of producing heated liquid, a certain amount of liquid is retained and can therefore ensure that a heated surface is covered sufficiently to prevent it overheating. Such a function could be achieved electronically or through use of a float but preferably a weir is provided such that liquid escapes over the weir and out of the final heating region when the water level in the region exceeds a predetermined height (determined by the height of the weir). An unheated region of the heater may be provided downstream of the weir.

In a set of embodiments a weir is provided in the final heating region, the height of which varies around its perimeter. This can allow greater control of the outflow rate for a given height of liquid in the final heating region. A suitable arrangement is described in WO 2011/077135.

In a set of embodiments an outlet is provided in the final heating region, the surface area of which increases with the height of liquid in the final heating region. This too can allow greater control of the outflow rate from the final heating region. In particular it can be configured to allow the liquid in the final heating region to maintain adequate coverage of the heating element across a range of inflow rates.

It has been found that the two features outlined above can be achieved using an outlet having a mouth shaped to conform approximately to the shape of a portion of the heating element disposed in the final heating region—e.g. so that the mouth is an approximately fixed spacing from the element. In another set of embodiments a weir is provided across the outlet, the open surface area of which increases with the height of liquid in the final heating region.

Preferably the outlet of the final heating region is arranged to allow liquid to drain therefrom to a level below a portion of the heating element in the final heating region when the inflow rate is below a predetermined threshold. This ensures that, should flow in the system slow dramatically or cease unexpectedly, the said portion of the element in the final heating region will overheat and trigger overheat protection before the part of the element in the heated flow conduit overheats as a result of the low flow rate. In one set of embodiments this is achieved by configuring the surface area of the outlet, or weir across the outlet, to increase with the height of liquid in the final heating region. The increase in surface area with height could be linear or non-linear.

As is discussed above, in accordance with preferred embodiments of the invention, steam is allowed to exit from the final heating region separately from the heated liquid. This is advantageous in a phase in which liquid is being conveyed from the heater to the beverage solids as it prevents the heated liquid being forced out by any steam associated with the heated liquid, resulting in unwanted spitting.

The conveying means may comprise any suitable flow pipe or tube for conveying heated liquid and steam to the head portion of the beverage maker. In a convenient set of the embodiments mentioned above a steam path and a heated liquid path are provided by a double tube arrangement, e.g. with one tube adjacent or inside the other, extending into the final heating region. The mouth of the steam path tube would be disposed at a level in the final heating region above the expected maximum level of liquid and the mouth of the liquid tube would be below this level. This arrangement thus maintains the important distinct paths for heated liquid and steam/vapor which is the key to minimizing spitting.

In one set of embodiments the steam outlet and the heated water outlet are both directed to a dispensing outlet. This is particularly convenient in the set of embodiments in which a double tube arrangement for the steam and heated liquid are provided. Arranging for both the steam and the heated liquid to exit through a common dispensing outlet is one way in which the apparatus can be pressurized, e.g. compared to an arrangement in which the steam outlet is directed to a different part of the apparatus. This arrangement is therefore suitable to be used in combination with the centrifugal or reciprocating pump as described earlier. In one set of embodiments the dispensing outlet comprises a shower head, i.e. arranged to distribute the heated liquid over the beverage solids e.g. coffee grounds.

In one set of embodiments the heater comprises control means arranged to select the mode of operation of the apparatus, i.e. the production of steam followed by the production of heated liquid, or vice versa, and in some embodiments the production of more steam after dispensing heated liquid. In the embodiments which comprise a pump, and/or a liquid level sensor, and/or one or more temperature sensors, preferably the control means are arranged to receive information from the sensors and to control the power of the heating means and/or the speed of the pump where provided to operate the machine in the desired modes.

The orientation of the apparatus, and particularly the heated flow conduit can be chosen to suit the form of the appliance in which the heater is employed. Conveniently in one set of embodiments the heated flow conduit is arranged to run horizontally, but in some embodiments the heated flow conduit is arranged to run vertically, e.g. to save space.

In the context of the present application a flow heater is defined as one which is able to heat liquid while it flows through and out of the heater.

Preferably the apparatus comprises a momentary-contact button or switch to energize a latching switch arrangement for powering the electronic control unit. This allows the electronic control unit also to achieve a very low or zero standby power. The button or switch could be located on the exterior of the appliance for operation by a user, e.g. an on-off switch, or it could be located on a component of the appliance which is moved into its operational place by a user to initiate a beverage production cycle, e.g. the means for receiving the beverage solids.

It is a preferred feature of the various aspects of the invention outlined above that heated liquid is conveyed into contact with beverage solids contained in an infusion means or an infuser. Preferably the infuser is removable, so that it can be discarded after use for a new infuser or so that it can be emptied and refilled. However many infusers are designed to contain a fixed or standard quantity of beverage solids. A conventional beverage making apparatus may not be able to adapt to making infusion beverages such as coffee and tea in different quantities and/or strengths while retaining an optimum flavor.

There are generally two main types of apparatus commonly used to make infusion beverages, especially where water for the beverage is electrically heated by the apparatus rather than on a stovetop. A first type of beverage making apparatus, often known as a drip coffee maker or percolator, comprises an open infusion basket containing relatively coarse coffee grounds (or tea leaves). Water is heated in a reservoir to a temperature approaching boiling point, typically 80-100° C., and is then delivered into the filter basket at atmospheric pressure. The hot water filters through the beverage material in the basket under gravity and then drips out into a carafe that collects the infused coffee or tea beverage. A second type of beverage making apparatus is an espresso coffee machine, wherein water is heated e.g. in a thermoblock and then pumped under a high pressures of 5-20 bar through a compressed cake of finely ground coffee powder. The coffee powder is held in a filter basket provided by a “group handle” that can be locked into position under a “group head” that supplies the pressurized hot water.

In both types of coffee maker described above the respective filter baskets are generally of a standard size. In drip coffee makers the filter basket is typically sized to hold enough coffee grounds to make up to 1.5 L or 12 cups of coffee in the carafe. Although the basket can be only partly filled when it is desired to make fewer cups of coffee, this requires a user to measure out the amount of coffee grounds rather than simply filling the basket to the full level. In espresso makers the filter basket holds the 7 g of coffee powder used to make a single shot (30-40 ml) of espresso. No measuring is required as a user simply fills the basket for every use, but only one serving can be made at a time.

There are several features of conventional espresso makers that can make them less than ideal for use in a domestic setting. The high pressures used to force hot water through the coffee powder in the filter basket require the apparatus to form a very robust seal between the group handle and the group head. A sealing ring or gasket provided on the group head and/or handle is arranged to be compressed as the filter basket is locked onto the group head. Typically this is achieved by locating the filter basket and then rotating the group handle to connect it tightly in a bayonet locking mechanism. A substantial degree of manual dexterity and force is required to lock and unlock the group handle.

The high pressures used by an espresso machine mean that the apparatus needs to have high safety factors built in. It would be desirable for domestic coffee makers to be able to produce espresso-type beverages at lower operating pressures. Furthermore, it is labor intensive to use an espresso machine to make several servings of coffee as each shot must be separately filtered and the basket removed and refilled with coffee grounds between brew cycles. A drip coffee maker, on the other hand, can produce multiple servings from a single brewing operation but it can take some time for the beverage to infuse at atmospheric pressure and filter out of the basket. Some coffee drinkers find the beverage made by a percolator too weak for their taste.

There will now be described some further aspects of the invention and their preferred features which may be combined with any of the aspects and embodiments of the invention described hereinabove.

When viewed from another aspect the present invention provides a kit comprising: an infusion beverage maker comprising a head portion for delivering hot water into a removable infuser connected thereto in use; and a plurality of different infusers, each infuser comprising an infusion chamber providing a different volume for containing a beverage material for infusion; wherein the head portion comprises a peripheral sealing means and each of the different infusers comprises a corresponding peripheral flange arranged to be clamped against the sealing means when the infuser is connected to the head portion in use.

It will be seen that in accordance with this aspect of the invention the head portion of the infusion beverage maker provides a universal sealing connection that can be used with a number of different infusers which may not contain the same volume of beverage material. Each of the infusers has in common a peripheral flange that is preferably arranged to correspond in size/shape with the sealing means in the head portion. However, the volume of the infusion chamber that contains beverage material is not limited by the size or geometry of the sealing means. The infusion chamber volume of each infuser may differ in terms of its magnitude and/or shape. The Applicant has recognized that simply changing the depth of an infuser to contain different volumes of a beverage material, for a given cross-sectional area, may not be appropriate for small amounts of beverage material as a minimum depth is in fact desirable for percolation and infusion to take place effectively. By providing a peripheral flange that is common to all of the different infusers, there is freedom to design the dimensions of the infusion chamber for each infuser to optimize infusion of the volume of beverage material contained therein.

According to embodiments of the invention, different infusers can be designed to contain different amounts of a beverage material, such as coffee grounds or tea leaves, and/or designed to present different cross-sectional areas through which the hot water is filtered, while being interchangeable for use with the same head portion of the infusion beverage maker. This greatly enhances the flexibility of the beverage maker for making different beverages. Firstly, different infusers may be provided for the infusion of different volumes of beverage, e.g. a large infusion chamber for making several cups of coffee or tea and a small infusion chamber for making a single cup of coffee or tea. Secondly, different infusers may allow for the infusion of different strength beverages, e.g. an infusion chamber having a large cross-sectional area may be used to make a weak beverage while an infusion chamber having a smaller cross-sectional area but the same volume may be used to make a stronger beverage.

The plurality of different infusers preferably comprises at least two, three, four or more different infusers. The different infusers have the same peripheral flange that is arranged to correspond with the sealing means provided by the head portion and may therefore differ in terms of the cross-sectional area and/or depth of the infusion chamber inwardly of the flange that is provided to contain a beverage material for infusion. The plurality of different infusers may comprise two or more infusers comprising an infusion chamber having a different internal volume for beverage material. Preferably at least one of the plurality of infusers comprises an infusion chamber having an internal volume suitable to contain beverage material for a single cup (e.g. around 30-50 cm³ for espresso or 125-150 ml for black “Americano” coffee). Preferably at least one of the plurality of infusers comprises an infusion chamber having an internal volume suitable to contain beverage material for several cups (e.g. around 200 cm³ for espresso or 600 ml for Americano) or even 10-12 cups (e.g. up to 500 cm³ for espresso or 1.7-1.8 L for Americano). Of course different infusers designed to contain different types of beverage, for example coffee grounds or tea leaves, may have different volumes for the same volume of infused beverage that it is desired to make.

According to the solution described above, a beverage maker is adapted to provide for the infusion of different volumes and/or strengths of a beverage by providing a kit of different infusers. Each infuser preferably comprises an integral infusion chamber providing a different volume for beverage material than other infuser(s) in the kit. However, in other embodiments each infuser may comprise the same outer infuser with the peripheral flange but a different infusion chamber removably inserted therein. Therefore according to another aspect of the invention there is provided a kit comprising: an infusion beverage maker comprising a head portion for delivering hot water into a removable infuser connected thereto in use; and a plurality of different inserts for the removable infuser, each insert providing an infusion chamber with a different volume for containing a beverage material in the removable infuser; wherein the head portion comprises a peripheral sealing means and the infuser comprises a corresponding peripheral flange arranged to be clamped against the sealing means when the infuser is connected to the head portion in use.

It will be seen that in accordance with this aspect of the invention the infuser and head portion together form a sealing connection independently of the different inserts. Each of the infuser inserts can differ in terms of the cross-sectional area and/or depth of its infusion chamber. Each infuser insert may be pre-loaded or loaded by a user with a certain amount of beverage material. At least one of the inserts can be adapted to support a pre-packaged holder of beverage material, such as a permeable “pod” or “bag”. Such an insert may even be provided with piercing means so that a sealed package or “pod” of beverage material supported therein can be pierced open when the infuser with its insert is connected to the head portion. At least one of the infuser inserts may be adapted to support a filter paper for holding beverage material in use. The Applicant has recognized that a problem with using filter papers is that some liquid can flow down the outside of the filter paper without fully passing through the beverage solids. Preferably the insert comprises a feature that contacts a base of the filter paper and forms a barrier to flow from around the outside of the filter paper. This enables a filter paper to be used with an insert to remove fine particles that could otherwise form a residue in the beverage receptacle, but without the filter paper affecting the degree of infusion achieved. There is therefore provided a great degree of flexibility in the beverage materials and infusion techniques that can be used with the beverage maker.

The sealing connection between the head portion and the removable infuser can be advantageous even when a kit of different infusers, or infuser inserts, is not provided. Rather a single infuser with an infusion chamber may be used. Thus in alternative embodiments a user may simply load a desired amount of beverage material into the infusion chamber and then connect the infuser to the head portion of the beverage maker via the peripheral sealing means. The sealing connection can enable the infusion chamber to be pressurized above atmospheric pressure, and various clamping arrangements may be provided, as will be described in more detail below.

The peripheral sealing means may take any geometrical form that prescribes a continuous seal around the periphery of an infuser when connected to the head portion in use. The sealing means is preferably annular and may, for example, be circular, oval or elliptical in shape. It will be appreciated that the sealing means may not be limited to the head portion and at least part of the sealing means may be provided by an infuser when connected thereto. However a benefit of providing the sealing means on the head portion, in addition to the universal fit discussed above, is that the seal is not on the removable part so it is less likely to be damaged than it would be if it were on an infuser that is repeatedly removed, emptied, cleaned, re-filled and replaced. Because the beverage material such as coffee grounds is contained in the infuser then it may also be less likely to interfere with the sealing means when provided on the head portion and to compromise the seal.

In one set of embodiments the peripheral flange of the infuser comprises a sealing surface. The sealing surface may be substantially flat. Or the sealing surface may be shaped so as to accommodate the sealing means of the head portion, for example with an annular groove arranged to receive an O-ring seal. However a potential problem with such sealing surfaces is that beverage material such as coffee grounds may spill onto the surface when the infusion chamber is filled and prevent a good seal from being formed. It is therefore preferred that in at least one set of embodiments the sealing surface on the peripheral flange comprises a sharp ridge or “knife edge”. The effect of the ridge is two-fold: preventing beverage material such as coffee grounds from resting on the sealing surface; and also increasing the sealing force by biting into the sealing means on the head portion.

The peripheral sealing means may simply act to form a substantially watertight connection between the head portion and one of the infusers. This can ensure that hot water delivered by the head portion does not splash out or escape from the infuser and potentially scald a user. Thus in one set of embodiments the head portion may deliver hot water substantially at atmospheric pressure. This may correspond to one mode of operation of the infusion beverage maker, similar to a drip type coffee maker.

However, in a preferred set of embodiments the head portion is arranged to deliver pressurized hot water. Thus the sealing means is preferably arranged to maintain a pressure above atmospheric in the infuser. The Applicant has recognized that it may be desirable, for example when the beverage maker is designed for use in a domestic setting, for the operating pressure to be relatively low as compared with conventional pressurized coffee makers such as espresso machines. This can make the beverage maker safer for home use while still providing a stronger infusion beverage e.g. than is possible with an atmospheric pressure percolator. Thus in at least one set of embodiments the pressure in the infuser is preferably between 0 and 0.5 bar, further preferably between 0 and 0.3 bar, yet further preferably between 0 and 0.2 bar above atmospheric pressure. In one set of embodiments infusion takes place in the infuser at a pressure of around 0.2 bar above atmospheric for the majority of the infusion cycle. It will be appreciated that the pressure may vary during an infusion cycle, with substantially zero pressure when hot water first flows through the dry beverage material and an increasing pressure as the material is wetted and becomes compacted.

Each of the plurality of different infusers comprises a peripheral flange that can be clamped against the sealing means during use. The clamping means may be separate from both the head portion and the infuser. However it is preferred that a means for clamping one of the infusers against the sealing means is integrally provided by either the infuser and/or head portion, for ease of use and to minimize the number of separate components. Each infuser may be provided with means that allow it to clamp itself in a final position against the head portion. The infuser may comprise e.g. a bayonet fitting, cam surface, or screw thread that is arranged to clamp the infuser against the sealing means as the infuser is rotated into a final position. Such arrangements are similar to the locking mechanisms used in conventional espresso makers to seal the group handle against the group head.

The Applicant has appreciated that it may not be ideal for the infuser itself to comprise means for clamping against the sealing means of the head portion, as this usually requires manipulation of the infuser to apply the clamping force. Additional manipulation can be difficult in practice as a user is already holding the infuser while trying to initially position it against the head portion without spilling the beverage material e.g. coffee grounds contained therein. Thus in a preferred set of embodiments the head portion comprises means for clamping an infuser in a final position against the sealing means. The clamping means provided by the head portion may be applied independently of the infuser so that the user does not have to manipulate the infuser other than putting it into an initial position. The positioning of the infuser may even be automated rather than completely manual.

The head portion may comprise any suitable means for releasably clamping an infuser in a final position with its flange against the sealing means, such as, for example, mechanical, electromechanical, electromagnetic or other clamping means. In some embodiments the clamping means may act while an infuser is being positioned against the head portion. The head portion may comprise support means for the peripheral flange that support an infuser in an initial position in use. The support means may be arranged such that the flange of an infuser is forced against the sealing means as the infuser is brought into contact with the support means. For example, the support means may be resiliently mounted against the sealing means such that the flange of an infuser can be pushed or slid between them with a clamping force automatically applied. Although such arrangements may allow positioning and clamping to be achieved at the same time, the simultaneous action of the clamping means may hinder a user in properly positioning one of the infusers.

In preferred sets of embodiments the head portion comprises a clamping means arranged to act independently from and/or subsequent to the infuser being initially positioned against the head portion. This can make it easier for a user to initially position an infuser in the apparatus without being hindered by clamping forces. In one set of such embodiments the head portion comprises support means for the peripheral flange of an infuser that allow the infuser to be initially positioned without coming into contact with the sealing means. For example, the head portion may comprise support means spaced from the sealing means. Thus a user can drop or slide an infuser into an initial position with its peripheral flange resting on the support means without having to push against or create sealing force. This can reduce the effort and dexterity required to attach the infuser to the apparatus.

Where an infuser can be placed in an initial position supported by the head portion without contacting the sealing means, then the clamping means preferably acts to bring the sealing means into contact with the peripheral flange of the infuser. Preferably the clamping means seals the infuser against the head portion after the infuser has been placed into an initial position.

In one set of embodiments the clamping means may be arranged to move the head portion to bring the sealing means into contact with the infuser. The clamping means may, for example, comprise a linear actuator or rotary mechanism arranged to push the head portion and its sealing means against the peripheral flange of the infuser. However the Applicant has realized that it may not be ideal to arrange for the clamping means to move the head portion against the infuser and rather it is preferable for the clamping means to be arranged to move the infuser to bring its peripheral flange into contact with the sealing means. This is considered novel and inventive in its own right, and thus when viewed from another aspect the present invention provides an infusion beverage maker comprising a head portion for delivering hot water and a removable infuser positioned in use to receive the hot water delivered by the head portion for infusion of a beverage material contained therein, the head portion comprising a peripheral sealing means and the infuser comprising a corresponding peripheral flange, wherein the head portion comprises means for supporting the infuser in an initial position and means for clamping the infuser in a final position, and wherein the clamping means is arranged, once the infuser is supported in the initial position, to move the infuser so as to bring the peripheral flange into contact with the sealing means in the final position.

According to this aspect of the invention an infuser is moved from an initial position, supported by the head portion, to a different, final position by clamping means provided by the head portion. The infuser is only clamped against the head portion in the final position after it has been placed into an initial position, improving ease of use, and furthermore it is the infuser that is moved rather than the head portion. Often the removable infuser will be lighter and/or simpler to move than the head portion as it may be a smaller part. The head portion is at least connected to a source for the hot water and may itself comprise, a heating means, so that it can be quite difficult to arrange for even part of the head portion to be moved by a clamping means. Such problems can be avoided by arranging for the clamping means to move the infuser into contact with the sealing means. A two-stage connection wherein an infuser is initially supported under a head portion and then clamped against the head portion in a different final position is a deviation from the connection of a group handle to the group head in an espresso machine, where the handle is turned to simultaneously connect the filter with a support means and to clamp the filter against the group head. Furthermore the clamping means is provided by the head portion according to the invention, so that clamping can be carried out independently of the infuser. The clamping means moves the infuser rather than the infuser being moved to provide a clamping force.

It is a preferred feature of all aspects of the invention that the peripheral flange of a or the infuser is clamped against the sealing means only after the infuser has been properly positioned under the head portion i.e. in an initial position to receive hot water. In other words, it is preferable for the infuser to be placed in an initial lateral position aligned so as to receive water from the head portion before it is clamped against the sealing means in a final position. Any suitable means may be provided to ensure proper positioning of the infuser before it is clamped, such as a mechanical interlock that only releases the clamping means once the infuser is in position. In preferred sets of embodiments the head portion comprises means for sensing when the infuser is in position. The sensing means may be a mechanical, electromechanical or electromagnetic sensor. In one set of embodiments the sensing means comprises a microswitch. In another set of embodiments the sensing means comprises a proximity sensor such as a magnetic field sensor.

As is mentioned above, the clamping means may be mechanical, electromechanical, electromagnetic or any combination of these. In one set of embodiments the clamping means may comprise a mechanical lever, for example with a spring-loaded over-center mechanism.

The Applicant has realized that an electromagnetic clamping means can provide certain advantages as it can be activated electrically without requiring any mechanical manipulation by a user and it may also reduce the number of mechanical or moving parts involved. Thus in a preferred set of embodiments the clamping means is an electromagnetic clamp such as a solenoid that can act to move the infuser, or at least part of it, by magnetic force so as to bring its peripheral flange into contact with the sealing means.

This is considered novel and inventive in its own right, and thus when viewed from a further aspect the present invention provides an infusion beverage maker comprising a head portion for delivering hot water and a removable infuser connected to the head portion in use to receive hot water for infusion of a beverage material contained therein, the head portion comprising a peripheral sealing means and the infuser comprising a corresponding peripheral flange, wherein the head portion comprises electromagnetic means arranged, when energized by an electrical current, to move the peripheral flange of the infuser so as to be clamped against the sealing means when the infuser is connected to the head portion.

It will be appreciated that using an electromagnetic clamping means to seal the infuser against the head portion can provide several benefits. Using an electromagnetic force to move the infuser into contact with the sealing means eliminates the need for a user to manually apply a sealing force. The beverage maker may therefore be easier to use. The sealing step can be automated and controlled so as only to take place once the infuser has been properly positioned. This can prevent the seal from being damaged by trying to force the infuser against the head portion in an incorrect position.

Where the head portion is provided with a sensing means, as is preferred, then an electrical signal from the sensing means indicating that the infuser is in an initial position is preferably used to activate the electromagnetic clamping means. This is a particularly advantageous embodiment that enables the infuser to be positioned and then sealed in two independent stages.

Although an electromagnetic clamping means can provide advantages in terms of independent and automatic sealing of the infuser to the head portion, the Applicant has recognized that the magnetic force typically provided by a solenoid having a size suitable for incorporation in a small domestic appliance may not always provide a very tight seal. The sealing force may be reduced if the magnetic force is working against the weight of the infuser. The sealing force may also be reduced if the magnetic force is working against the pressure of water flowing through the infuser. It is therefore preferred in some sets of embodiments that the electromagnetic clamping means comprises a solenoid arranged to move the peripheral flange of the infuser through a mechanical linkage. Preferably the mechanical linkage is arranged to augment the force applied by the solenoid on the infuser. The mechanical linkage may, for example, comprise an over-center or elbow latch mechanism that is flipped from an unlocked state to a locked state when the solenoid is energized. Such mechanisms can be arranged to apply a relatively high clamping force along a main axis while a lower force applied by the solenoid along a direction oblique to the main axis can lock/unlock the mechanism. Thus in a preferred set of embodiments the electromagnetic means is arranged to operate a clamping mechanism that can be moved between locked and unlocked positions, wherein in the locked position the clamping mechanism provides a clamping force along a main axis and wherein the clamping mechanism can be moved to the unlocked position by the electromagnetic means applying a force lower than the clamping force in a direction oblique to the main axis.

A mechanical linkage or mechanism can improve the sealing connection between the infuser and the head portion, which may be particularly important if the infuser is pressurized during use, as is described above. Furthermore an increase in the clamping force available from the electromagnetic means can be beneficial regardless of whether it is the infuser or the head portion that is being moved by the electromagnetic means. This is considered novel and inventive in its own right, and thus when viewed from a fourth aspect the present invention provides an infusion beverage maker comprising a head portion for delivering hot water, a removable infuser connected to the head portion in use to receive hot water for infusion of a beverage material contained therein, sealing means arranged between the head portion and the infuser, and electromagnetic clamping means arranged, when energized by an electrical current, to bring the infuser and/or head portion into contact with the sealing means so to clamp them together, wherein the electromagnetic clamping means comprises a clamping mechanism that can be moved between locked and unlocked positions, wherein in the locked position the clamping mechanism provides a clamping force along a main axis and wherein the clamping mechanism can be moved to the unlocked position by the electromagnetic clamping means applying a force lower than the clamping force in a direction oblique to the main axis.

Once a or the infuser has been initially positioned and then clamped/sealed against the head portion in a final position, the beverage maker is preferably controlled so as to supply hot water to the head portion and thus initiate an infusion cycle for the beverage material contained in the infuser. The sensing means may initiate the infusion cycle, for example sending a control signal to a heater/pump after a predetermined delay time permitting the infuser to have been clamped before the infusion cycle begins. The sensing means may act to bring the beverage maker out of a zero power or standby mode. Alternatively user intervention may be required to initiate an infusion cycle. This would allow a user to prime an infuser ready for use but then wait until a later time to make the beverage. The beverage maker may allow a user to input information relating to e.g. the type of beverage, the size of the infuser, the strength of beverage desired, etc. so that the apparatus can adjust the amount of hot water supplied and/or the pressure used.

The Applicant has realized that an electromagnetic clamping means may advantageously be used to provide an additional effect. By controlling the electrical current applied to the coil in the electromagnetic, its magnetic force and thus the clamping force on the infuser can be varied. The Applicant has realized that this can be used to depressurize or vent the infuser connected to the head portion. Thus in one set of embodiments the electromagnetic clamping means is preferably released so as to vent the infuser to atmosphere. This can be used, if desired or necessary, to release pressure from the infuser during an infusion cycle. The clamping means may therefore be released and re-energized at times throughout operation of the beverage maker. Of course, when the clamping means is released the seal may be broken so as to allow air to enter the infuser but the infuser may not be moved out of complete contact with the head portion so as to minimize the risk of hot water or steam from spitting out.

Additionally or alternatively to releasing pressure during an infusion cycle, the electromagnetic clamping means is preferably arranged to automatically release the infuser after the beverage material therein has undergone infusion. A benefit of venting the infuser at the end of an infusion cycle is that pressure is released and any hot water remaining in the head portion may flow out, allowing the water supply pipes to empty. This can prevent water from spitting or dribbling out when a user is removing the infuser, as often happens in a conventional espresso machine where the seal is only released when a user disconnects the group head. This can also prevent water and beverage from being sucked back through the heater/pump, for example if the water level in the water reservoir is lower than the outlet to the head portion, which could cause contamination within the apparatus. Another benefit of venting the infuser as soon as infusion is complete is that it can prevent a vacuum from being formed as the infuser cools down. By restoring atmospheric pressure it is ensured that the infused beverage can flow out of the infuser freely.

The infuser may take any suitable form as long as it is suitable for containing a volume of beverage material for infusion and comprises an outlet for the infused beverage. In preferred sets of embodiments the infuser comprises an infusion chamber wherein the beverage material is contained and infusion takes place. The infusion chamber may be integral to the infuser or it may be removable, allowing it to be filled and then replaced for use. The open cross-sectional area of the infusion chamber may be defined by the peripheral flange, with a larger flange extending inwardly to define a smaller cross-sectional opening for the chamber. The volume of the infusion chamber may be varied in terms of its magnitude and/or its shape and relative dimensions. For example, the infusion chamber may be generally cylindrical or conical in shape.

In one set of embodiments the infusion chamber comprises a mesh arranged above the outlet of the infuser. The mesh prevents grounds of coffee or other beverage material passing from the chamber into the outlet of the infuser and therefore potentially into the beverage. The mesh could comprise any suitable material, e.g. metal or plastic, and preferably is arranged to comprise openings which are sized to allow liquid through but trap coffee grounds. The mesh could extend solely across the outlet, but preferably the mesh extends at least part or all the way across the infusion chamber at a level above the outlet. This allows the outlet of the infuser and/or the mesh to comprise further advantageous features which will be discussed below.

In one set of embodiments the Applicant has found that it is advantageous to provide a baffle or wall at a level above the outlet to prevent fine coffee grounds passing straight into the outlet through the mesh. Preferably the baffle or wall comprises an area greater than or equal to the cross sectional area of the outlet. The baffle or wall could be provided instead of a mesh, but in a preferred set of embodiments it is in addition to the mesh. The baffle or wall may be provided as a separate part, e.g. at a level above or below the mesh, but preferably the baffle or wall is mechanically coupled to the mesh, e.g. the mesh extends around the baffle or wall, preferably with the mesh not extending across the outlet.

In another set of (not necessarily mutually exclusive) embodiments in, the outlet comprises means to permit automatic outflow of beverage upon the liquid reaching a predetermined level. By providing a predetermined minimum level, any fine grounds of coffee which happen to pass through the mesh (where provided) are given chance to settle in the liquid that is below the predetermined level, and therefore are less likely to pass into the outlet. This can be provided in addition to or instead of the baffle or wall, and/or the mesh to further help to prevent coffee grounds passing through the outlet of the infuser.

Conveniently the means to permit automatic outflow of beverage upon the liquid reaching a predetermined level comprises a weir, such that beverage escapes over the weir and out of the outlet when the liquid level in the infusion chamber exceeds a predetermined height (determined by the height of the weir). This therefore provides a region below the weir in which coffee grounds or other beverage material can settle and collect so that they do not pass through the outlet.

The base of the infusion chamber could also be shaped such that it tapers towards the outlet, i.e. reduces in cross sectional area. This encourages any fine material particles which may have passed through the mesh to aggregate around the base of the outlet below the predetermined level where they are unlikely to become entrained in the liquid and are therefore prevented from passing out through the outlet.

When viewed from a further broad aspect the present invention provides an electrical infusion beverage maker comprising a liquid heater and a pump arranged to supply a head portion with pressurized hot water and/or steam, an infuser containing a beverage material being sealingly connected, in use, to the head portion for infusion of a beverage at a pressure of 0.1 to 0.5 bar above atmospheric pressure.

### BRIEF DESCRIPTION OF THE DRAWINGS

Certain embodiments of the invention will now be described, by way of example only, with reference to the accompanying drawings in which:

FIG. 1 is a perspective view showing the main components of an infusion beverage maker according to one embodiment of the invention;

FIGS. 2 and 3 are vertical sections showing the interior of the boiling pool of FIG. 1;

FIG. 4 is a closer perspective view of the head portion of the infusion beverage maker of FIG. 1;

FIG. 5a is a perspective view of a large infusion basket according to one embodiment and FIG. 5b is a perspective view of a small infusion basket according to another embodiment;

FIG. 6 is a cross-sectional view through the head portion of FIG. 1 with the infusion basket of FIG. 5a connected thereto;

FIG. 7 is a cross-sectional view through the head portion of FIG. 1 with the infusion basket of FIG. 5b connected thereto; and

FIG. 8a and FIG. 8b are schematic cross-sectional views of a clamping mechanism according to an alternative embodiment, shown in unlocked and locked positions;

FIG. 9 is a cross-sectional view showing some of the main components of an infusion beverage maker according to another embodiment of the invention;

FIG. 10 is a perspective view of the liquid heating and dispensing components of the infusion beverage maker of FIG. 9;

FIG. 11a is a schematic diagram of the main components of an infusion beverage maker according to an embodiment of the invention, with detail of the heater shown in FIG. 11b;

FIG. 12a is a perspective cross-sectional view of an infuser in a first configuration, FIG. 12b is a perspective cross-sectional view of an infuser in a second configuration, FIG. 12c is a cross-sectional view of the infuser insert of FIG. 12b, and

FIGS. 12d-12h are partial views of different details for the insert;

FIG. 13 is a perspective view of a carafe for receiving infused beverage; and

FIG. 14 is a flow diagram for the operation of an infusion beverage maker.

### DETAILED DESCRIPTION OF THE INVENTION

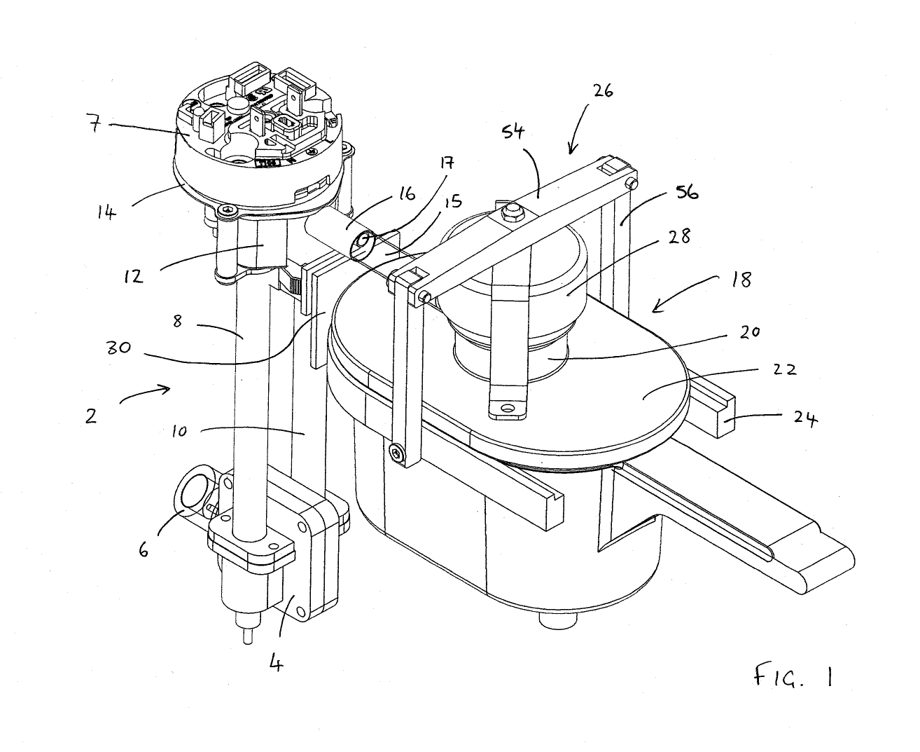

FIG. 1 shows some of the main internal components of an embodiment of the invention which can be used to make infusion beverages such as coffee. Some parts of the apparatus, such as an outer housing and water tank, are omitted for clarity. From FIG. 1 there may be seen a vertical water heater 2 comprising a water distribution plenum block 4 at its lower end. Water enters the distribution plenum block 4 from a side inlet 6 connected to a water tank and centrifugal or reciprocating pump (not shown). The plenum block 4 distributes the water between two parallel flow heater sections 8,10.

At the downstream (upper) end of the flow heater portions 8,10 is a boiling pool 12. This is formed by a deep-drawn stainless steel cup fitted below an approximately circular stainless steel element head 14. The boiling pool 12 has an outlet pipe 16 projecting laterally to supply heated water to the head portion 18 of the apparatus.

Each of the parallel flow heater sections 8, 10 comprises an outer jacket and a length of a sheathed immersion-type heating element in an arrangement as set out in WO 2010/106349 or WO 2011/077135. The two flow heater sleeves are wider in diameter than the corresponding heating element and so define therebetween a corresponding annular channel for each of the flow heater sections 8, 10. Therefore there is a fluid path from the distribution plenum block inlet 6, via the distribution plenum block 4 to the interior annular channels of the two flow heaters 8, 10.

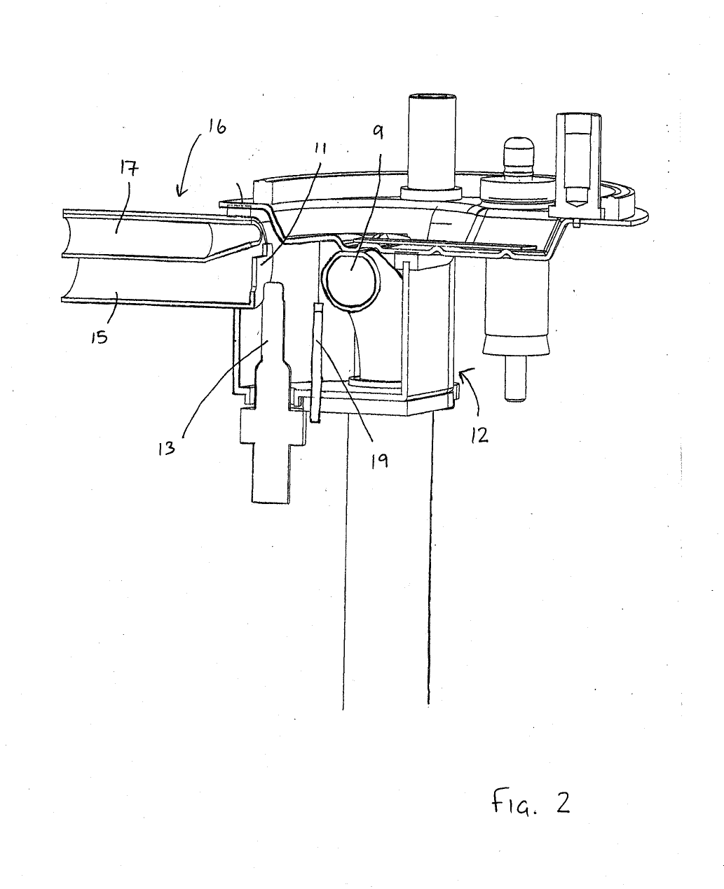

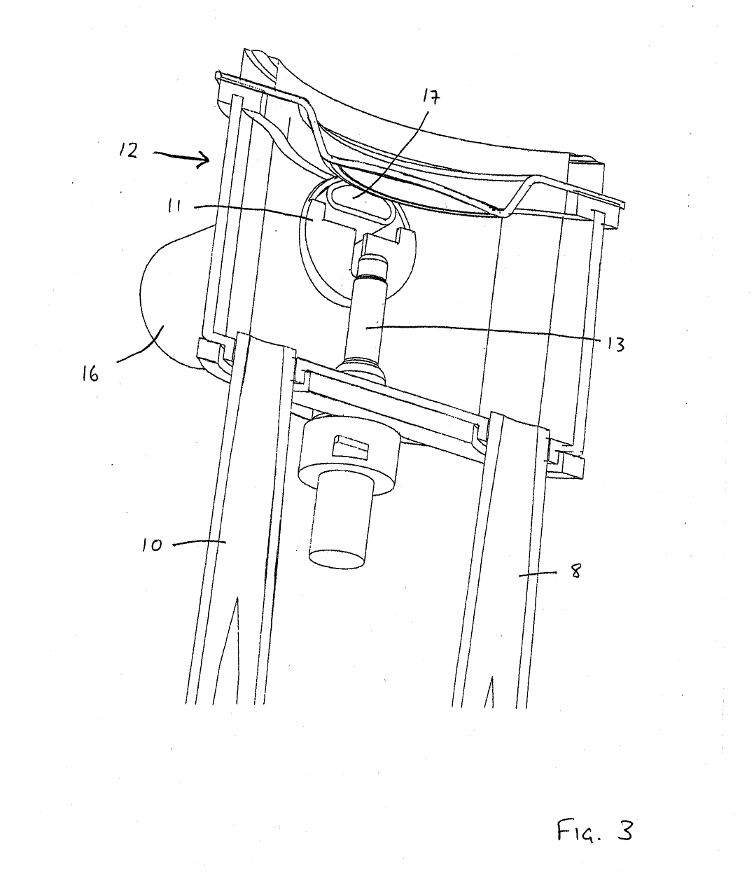

The outlet pipe 16 comprises a water outlet 15 (see FIGS. 2 and 3) which exits the boiling pool 12 horizontally, and has a steam tube 17 off-center within it. The steam tube 17 forms an outlet for steam and vapor from the boiling pool 12 separate from the outlet path for heated liquid. The outlet pipe 16, and therefore also the water outlet 15 and steam tube 17, are fluidically connected to the head portion 18 of the apparatus.

The interior of the boiling pool 12 is best seen from the view of FIGS. 2 and 3. From here it can be seen that the boiling pool 12 formed by the stainless steel cup is broadly of a squat cylindrical shape although its internal volume is limited by the bent portion of the heating element 9 that extends between the two flow heater sections 8, 10. The water outlet tube 15 exits from an upper part of the boiling pool 12, and has its lower portion covered by a weir 11. The steam outlet tube 17 has its mouth at the top of and within the water outlet tube 15. A thermistor 13 projects through the base of the boiling pool 12 and has its tip at the level of the bottom of the weir 11. A water level sensor 19 also projects through the base of the boiling pool 12 and has its tip at a level just below the bottom of the weir 11.

The weir 11 has a wider cross section in its upper portion and a narrower cross section (a slit) in its lower portion. This restricts the flow of water into the water outlet tube 15 thus ensuring that the heating element 9 remains adequately covered in water, so preventing overheating in the second phase of operation, i.e. dispensing heated water. A second function of the shape of the weir 11 is that, by having a smaller cross section in its lower portion, at the level of the bottom of the heating element 9, the boiling pool 12 drains quickly if the water flow from the flow heaters 8, 10 is suddenly reduced or stopped—owing, for example, to a blockage in the flow heaters 8, 10. This causes the highest part of the heating element 9 to overheat which can quickly be sensed via the hot return, though the minimum level of the top of the outlet tube 16 is still high enough for some water to remain in the bottom of the boiling pool 12 to provide a reliable temperature measurement from the thermistor 13.

In a first phase of operation the water level is below the level of the weir 11 so that water is not dispensed from the boiling pool 12, but is still enough to adequately cover the heating element 9 with water, therefore also preventing overheating in the first phase of operation, i.e. producing steam. The cross sectional area of the mouths of the steam tube 17 and the water outlet tube 15 are chosen such that the boiling pool 12 becomes slightly pressurized (e.g. to about 0.2 bar above atmospheric) during operation.

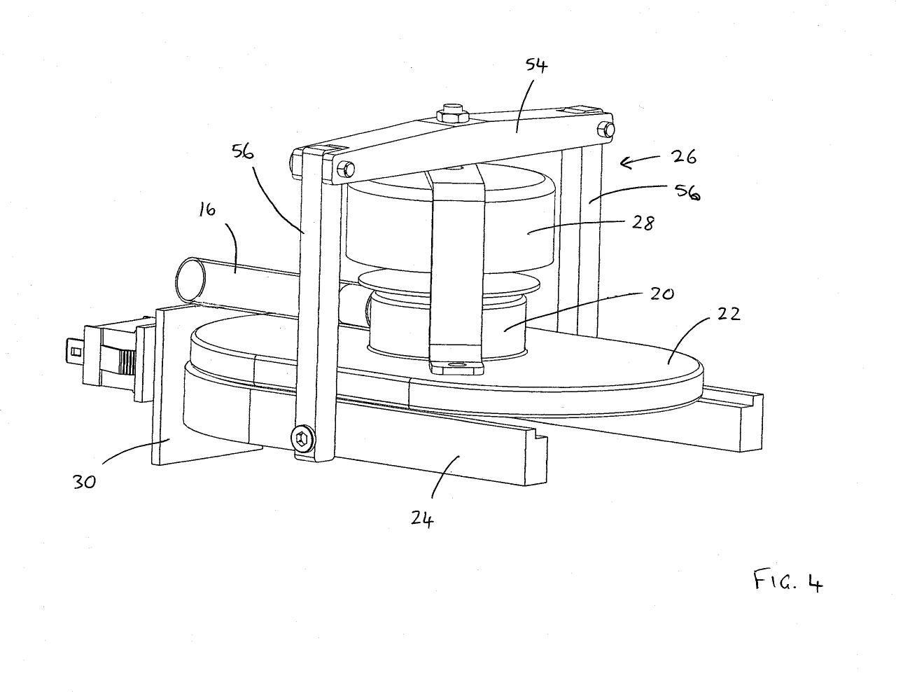

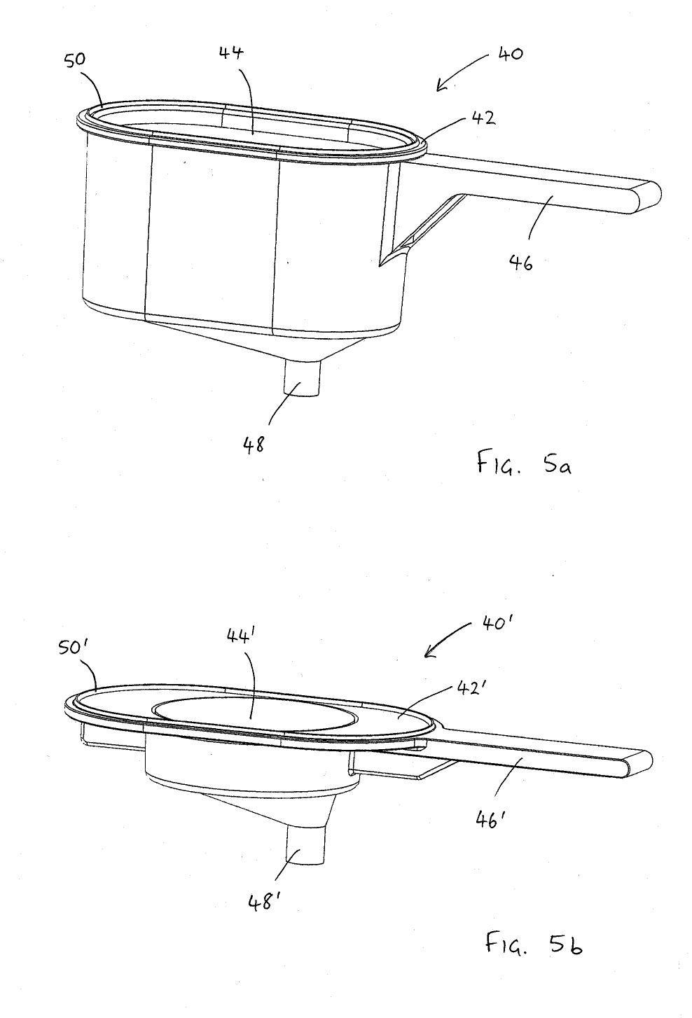

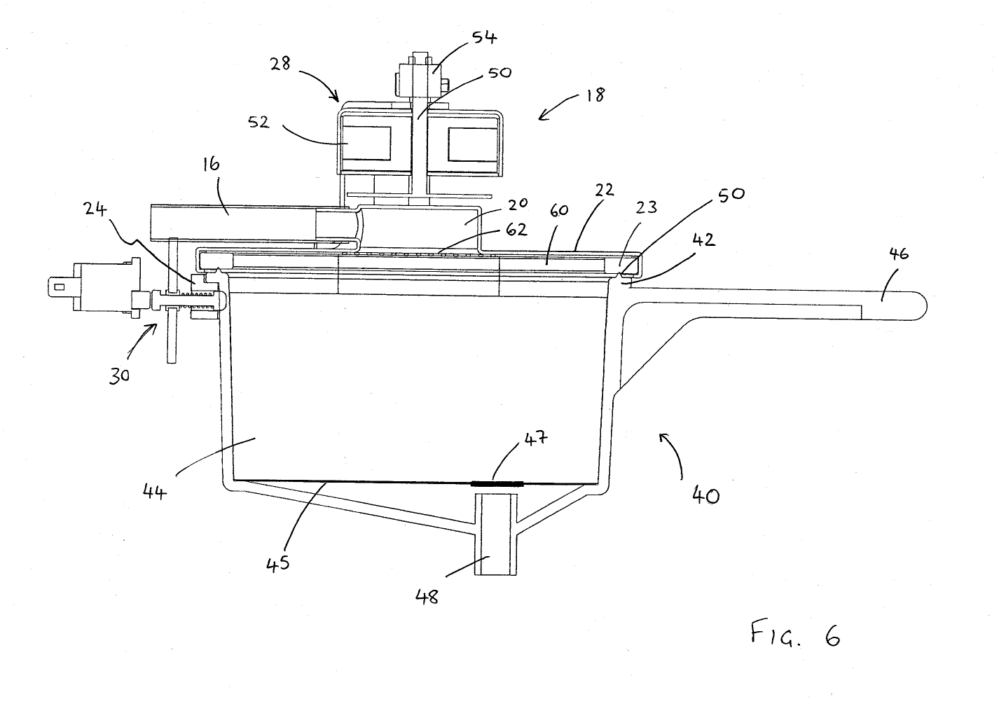

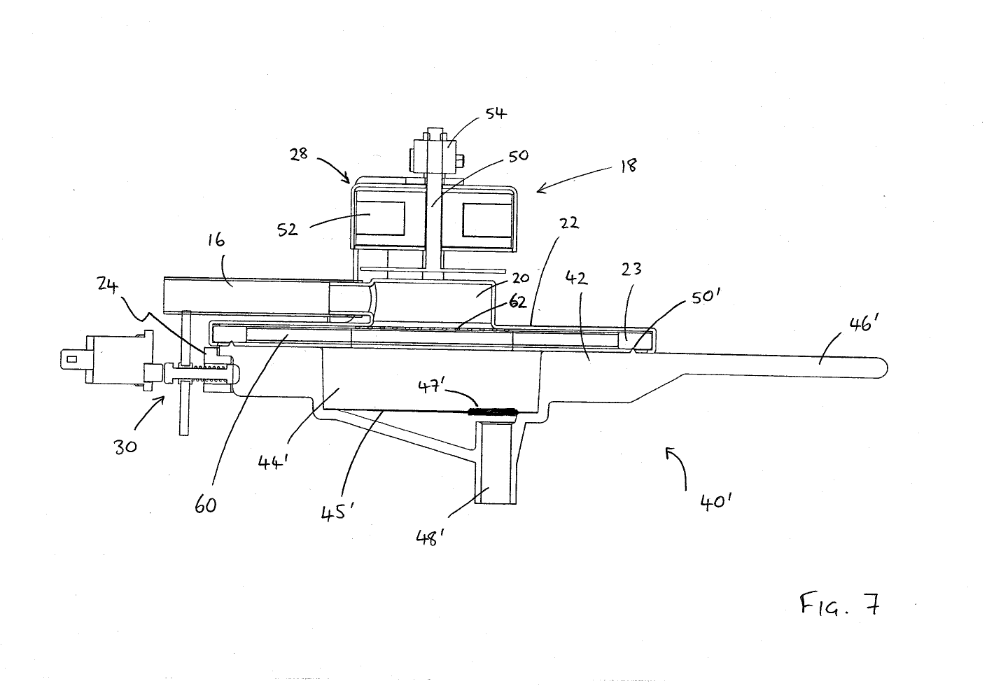

The head portion 18 is seen in FIG. 1 and in closer detail in FIG. 4. The water supply pipe 16 from the heater 2 is connected to a delivery chamber 20 arranged above a sealing flange 22. These parts of the head portion 18 remain stationary during use. Located below the sealing flange 22 is a U-shaped support 24 that can receive an infusion basket. The U-shaped support 24 can be moved vertically upward relative to the sealing flange 22 by a linkage frame 26 that extends from one side arm of the support 24 and up and over to the other side arm of the support 24. Arranged on top of the delivery chamber 20 and below the linkage frame 26 is a solenoid 28 that moves the frame 26 when energized with an electrical current.

The solenoid 28 is electrically connected to a microswitch sensor 30 positioned on the apex of the U-shaped support 24. The microswitch 30 is arranged to sense when an infusion basket is slid all the way along the arms of the support 24 and positioned beneath the sealing flange 22. Until the microswitch 30 is activated, the support 24 is spaced from the sealing flange 22 so that there is room for the peripheral flange of an infusion basket to be slid along the arms of the support 24 freely. A peripheral seal 23 on the underside of the sealing flange 22 is not contacted until the solenoid 28 and linkage frame 26 act to pull the U-shaped support 24 closer to the sealing flange 22.

Two different infusion baskets are shown in FIG. 5. In FIG. 5a the infusion basket 40 is a large size designed to make several cups of beverage in a single infusion cycle. In FIG. 5b the infusion basket 40′ is a small size designed to make a single cup of beverage. Both of the infusion baskets 40, 40′ have in common a peripheral flange 42, 42′, an infusion chamber 44, 44′, and a handle 46, 46′. The infusion chambers 44, 44′ are provided with an outlet 48, 48′ through which infused beverage can drain into a cup or carafe. On the upper sealing surface of the peripheral flanges 42, 42′ there is provided a knife edge ridge 50, 50′.

As the infusion basket 40 shown in FIG. 5a is a large size, its peripheral flange 42 is narrow and the infusion chamber 44 defines a large cross-sectional area for containing beverage material and for receiving hot water from the head portion 18. The infusion chamber 44 is also relatively deep so as to maximize its volume. On the other hand, the infusion basket 40′ shown in FIG. 5b is a small size with a wide peripheral flange 42′. The infusion chamber 44′ defines a much smaller cross-sectional area for containing beverage material and for receiving hot water, as well as being shallower. The wider peripheral flange 42′ circumscribes the infusion chamber 44′ so that the outer periphery of the infusion basket 40′ is the same as that in FIG. 3a. It should be noted that despite the different dimensions of the two infusion chambers 44, 44′, the outlets 48, 48′ are in the same lateral position, i.e. radial distance, relative to the common outer periphery of the flanges 42, 42′. This means that the outlet 48, 48′ is always in the same lateral position relative to the water delivery chamber 20 in the head portion 18, so that the flow patterns are comparable even for different infusion baskets 40, 40′.

In both FIGS. 5a and 5b the outer periphery of the peripheral flange 42, 42′ is identical in shape and size, with the same sealing surface carrying the knife edge ridge 50, 50′. It is this part of the peripheral flange 42, 42′ that corresponds with the peripheral seal 23 on the underside of the sealing flange 22 provided by the head portion 18. Accordingly the two infusion baskets 40, 40′ can be connected interchangeably to the same head portion 18 with a common sealing interface, as is seen from FIGS. 6 and 7.

Turning first to FIG. 6, there is shown the infusion basket 40 of FIG. 5a after it has been connected to the head portion 18 of the beverage maker. In order to make a beverage, a user first fills the chamber 44 of the infusion basket 40 with beverage material such as coffee grounds (not shown). For a large chamber 44 designed to make up to 12 cups of beverage, coarse grinds may be used so that water can percolate through in a reasonable period of time. The infusion basket 40 is then positioned under the head portion 18 by resting its peripheral flange 42 on the ends of the arms of the U-shaped support 24 and sliding the basket 40 along the arms so that the peripheral flange 42 is positioned below the sealing flange 22 of the head portion. The infusion basket 40 can be positioned with ease as there is a vertical gap between the U-shaped support 24 and the sealing flange 22 that allows the peripheral flange 42 to pass without contacting the seal 23 on the underside of the flange 22.

When the infusion basket 40 has been pushed right under the head portion 18 its peripheral flange 42 contacts the microswitch 30 and this activates the solenoid 28. In this embodiment the solenoid 28 comprises a metal rod 50 that passes through the center of a coil 52 and is pulled vertically down when the coil 52 is energized with a current. The rod 50 (seen in FIG. 6) is fixed to a central point on a horizontal crossbar 54 in the linkage frame 26. The ends of the crossbar 54 are pivotally connected to vertical side arms 56 of the frame 26, as is seen from FIG. 1 or FIG. 4. When the crossbar 54 is pulled down by the rod 50 being pulled into the coil 52, the pivoting connection cause the side arms 56 to pull up and thus to move the U-shaped support 24 up so that the peripheral flange 42 of the infusion basket 40 comes into contact with the sealing flange 22. The knife edge ridge 50 on the surface of the peripheral flange 42 compresses the seal 23 on the underside of the flange 22. As long as the solenoid is energized there is a clamping force holding the two flanges 22, 42 against each other with a sealed interface around the periphery of the infusion basket 40.

Exactly the same procedure as described above is carried out to position and clamp the smaller size infusion basket 40′ as shown in FIG. 7. Comparing FIGS. 6 and 7, it can be seen that the only difference is in the volume of the two infusion chambers 44, 44′. The same sealing interface is formed between the peripheral flange 42′ of the smaller infusion basket 40′ and the sealing flange 22 of the head portion 18 as is formed for the larger infusion basket 40.

From the cross-section shown in FIGS. 6 and 7 it can also be seen that the water delivery chamber 20 in the head portion 18 opens into a distribution cavity 60 defined at its upper end by the hood of the sealing flange 22. At the interface between the delivery chamber 20 and the distribution cavity 60 there is provided a perforated cover 62 that acts to distribute the hot water in a similar way to a shower head. This helps to ensure that hot water is sprayed over most, if not all, of the open area of the infusion chamber 44. The peripheral seal 23, which may be a silicone O-ring, prevents any hot water or steam from escaping. The sealed connection can also allow the infusion chamber 44 to be at an elevated pressure e.g. 0.1 or 0.2 bar above atmospheric pressure.

From the cross-section shown in FIGS. 6 and 7 it can also be seen that the infusion baskets 40, 40′ each comprise a mesh 45, 45′ which extends across the bottom of the basket 40, 40′ at the level of the bottom of the side walls, i.e. above the outlet 48, 48′. The mesh 45, 45′ is arranged to hold the coffee grounds above it during the brewing process and to prevent any grounds passing through it and into the outlet 48, 48′. To further prevent fine grounds of coffee passing straight into the outlet 48, 48′, a disc-shaped impermeable portion 47, 47′ with a surface area slightly greater than the cross sectional area of the basket outlet 48, 48′ is provided in the mesh 45, 45′ directly above the outlet 48, 48′. The disc-shaped portion 47, 47′ could simply be a part of the mesh with no holes in it, or a solid portion, e.g. made from plastic, placed over the top of the mesh 45, 45′.

If some coffee grounds do happen to pass through the mesh 45, 45′, the infusion basket 40, 40′ is provided with an outlet 48, 48′ which protrudes into the chamber 44, 44′ from the base of the basket 40, 40′. This protrusion acts as a weir so that the brewed liquid has to rise above a minimum level (the height of the weir) to be dispensed from the basket 40, 40′. The effect of this is to trap a small volume of liquid in the bottom of the basket 40, 40′ in which any coffee grounds that have passed through the mesh 45, 45′ will accumulate and settle, therefore preventing them from flowing into the outlet 48, 48′. The mesh 45, 45′, the disc-shaped portion 47, 47′ and the weir therefore act together to prevent any coffee grounds from ending up in a user's cup.

Operation of the beverage maker will now be described. A user starts by selecting an infusion basket 40, 40′, e.g. depending on the quantity and/or strength of beverage required. Beverage material such as coffee grounds are placed in the infusion chamber 44, 44′ and tamped down if desired. The infusion basket 40, 40′ is positioned under the head portion 18 by resting the peripheral flange 42, 42′ on the U-shaped support 24 and sliding the basket 40, 40′ under the sealing flange 22 until it reaches the apex of the support 24. Regardless of the size of basket 40, 40′, at this stage the peripheral flange 42, 42′ will be aligned below the seal 23 on the sealing flange 22 and only when properly aligned will the peripheral flange 42, 42′ contact the microswitch 30 and indicate the presence of the basket 40, 40′. The microswitch 30 may operate to automatically energize the solenoid 28 and thus operate the linkage frame 26 to pull the infusion basket 40, 40′ up to clamp it against the sealing flange 22. The apparatus is then ready to start an infusion cycle. This step may not be automated, however, and instead user intervention may be required to initiate the clamping step at a time when it is intended to use the beverage maker.

If necessary, the user will fill the water tank (not shown), e.g. from a tap. When the user wishes to initiate the infusion cycle he/she presses a switch or other input on the appliance. The appliance may already have moved out of a zero power or standby mode upon receiving a signal from the sensor 30 that an infusion basket 40, 40′ has been connected to the head portion 18. At this point the user may be able to input information concerning the amount or type of beverage, or one of several infusion programs may be selected. Once a suitable signal is given, either automatically or from the user's input, the controlling circuit (not shown) activates the heating element 9. After a delay of one or two seconds (depending on the temperature of the water already in the heater) the pump is operated to pump water from the water tank into the distribution plenum block 6. In other embodiments the pump may be started before the heater 2.

Once water has been pumped into the distribution block 6, it is pumped through this and down the annular channels of each of the two flow heaters 8, 10 between the heating element 98 and the corresponding stainless steel outer jacket. This heats the water rapidly as it passes through from ambient temperature (of the order of 20° C.) in the distribution block 16 to approximately 85° C. at the downstream ends of the flow heaters 8, 10.

In a first phase of operation (steam production) the water then passes out of the flow heaters 8, 10 and into the interior of the boiling pool 12 where it begins to partially fill this pool. The water level is monitored using a sensor 19. This information is fed back to the controlling circuit which in turn controls the speed of the pump in order to keep the level of the water below the bottom of the weir 11, i.e. to prevent any water being dispensed. Steam is generated and escapes the boiling pool 12 by means of the steam tube outlet 17 at the top. A steam pressure is allowed to develop as a result which is sufficient to force steam through the apparatus downstream of the boiling pool 12, i.e. through the steam tube 17 in the outlet pipe 16 and into the head portion 18. This steam acts to warm the outlet pipe 16 as well as the components in the head portion 18 prior to dispensing heated water from the boiling pool 12, as well as ejecting any liquid which has been retained in the appliance from the previous cycle of operation. Alternatively, such a steam production phase may be initiated after a liquid dispensing phase to act as a steam purge that ejects any remaining water and/or steam from the heater and dries the contents of the infusion basket so as to assist in depressurization.

In general the speed of the pump is varied to cope with changes in the appliance over time, e.g. the pressure drop (which may be due to scale build-up), different types of beverage solids, e.g. fine or coarse ground coffee, the packing density of the beverage solids, the water level in the reservoir or pressure from an external source, etc. Initial safety testing of the appliance sets a minimum flow rate in the controlling circuit as a start condition. This flow rate guarantees boiling of the water in the boiling pool and ensures that the initial volume of water passed through the appliance is heated up very quickly which also results in the steam in the first phase of operation being produced as quickly as possible, reducing the time taken for the final beverage to be produced.

The curved part of the heating element 9 continues to heat the water in the boiling pool 12, now producing significant numbers of bubbles which break the surface of the pool of water in the boiling pool 12 and escape as steam. This encourages prolonged boiling of the water in the boiling pool 12 which creates steam that can easily escape the boiling pool 12 by means of the steam tube outlet 17 at the top of it. A steam pressure is allowed to develop as a result which is sufficient to force steam through the apparatus downstream of the boiling pool, i.e. through the steam tube 17 in the outlet pipe 16 and into the head portion 18. This steam acts to warm the outlet pipe 16 as well as the components in the head portion 18 prior to dispensing heated water from the boiling pool 12, or to dry out the components after a dispensing cycle, as well as ejecting any liquid which has been retained in the appliance from the previous cycle of operation.

After a predetermined period of time, i.e. calculated to be sufficient for the steam produced to have heated or dried all of the necessary components downstream of the boiling pool 12, the controlling circuit changes the phase of operation of the appliance to dispensing heated water, i.e. a second phase. As will be described below, the heated water may be delivered to the infusion basket 40, 40′ or it may be delivered to a path bypassing the infusion basket 40, 40′. In an alternative embodiment a temperature sensor could be used to decide when the downstream components are hot enough, or a pressure sensor could be used to detect when the infusion basket has been sufficiently depressurized, to switch to the second phase. The input to the controlling circuit is now the thermistor 13 in the boiling pool 12, which is used to control the speed of the pump in order to raise the level of the water above the bottom of the weir 11 so that heated water can be dispensed through the water outlet 15, but at a flow rate to ensure that the water is heated to a temperature of between 93 and 95° C., i.e. suitable for brewing coffee. However, the appliance in accordance with the present invention is also suitable for heating water to brew tea or other beverages, and in this situation, the water may be heated to a different, e.g. higher, temperature which is suitable for brewing tea or other beverages. The pumped flow rate and the power of the heating element 9 are therefore matched, via feedback from the thermistor 13 through the controlling circuit, such that by the time the water leaves the boiling pool 12 over the weir 11 and through the outlet tube 15 it is at the required temperature.

In this second phase of operation, when water begins to fill the boiling pool 12 after passing out of the flow heaters 8, 10, the curved portion of the heating element 9 is covered during normal operating conditions. The temperature of the water in the boiling pool 12 is monitored by the thermistor 13 which projects into the boiling pool 12 near the outlet 15. The curved part of the heating element 9 continues to heat the water in the boiling pool 12. Any steam produced from micro-boiling during heating of the water in the boiling pool 12 can easily escape by means of the steam tube 17 which opens at the top of it. The steam passes through the steam tube 17 and into the head portion 18, i.e. the same outlet as the heated water which acts to pressurize the boiling pool 12. As the steam tube 17 runs through the water outlet tube 15 it advantageously helps to keep the heated water warm as it passes from the boiling pool 12 into the head portion 18. The boiling pool 12 and the separation of the steam through the steam tube 17 from the water outlet 15 gives the advantage that water can be dispensed without spitting.

The height and shape of the weir 11 is chosen to ensure that the element 9 remains covered in water during normal flow rate in the second phase of operation but quickly drains the boiling pool 12 if the flow rate drops in order to quickly trigger a snap-acting bimetallic actuator connected to the other side of the hot return (not shown in this embodiment). The boiling pool 12 and the separation of the steam through the steam tube 17 from the water outlet 15 gives the advantage that water can be dispensed without spitting and localized hot spots on the heating element from micro-boiling.

Water flows from the water outlet 15 along the water supply pipe 16 from the heater to the delivery chamber 20. When hot water enters the delivery chamber 20 in the head portion 18, it is forced under pressure through the perforated cover 62 so as to shower down from the distribution cavity 60 into the infusion chamber 44, 44′ connected below. Water percolates down through the coffee grounds and the infused beverage flows out of the bottom outlet 48 to be collected in a receptacle such as a cup or carafe. After the beverage material in the infusion chamber 44, 44′ is initially wetted the flow resistance will increase and the pressure contained in the infusion basket 40, 40′ may increase to around 0.2 bar above atmospheric pressure.

The infusion cycle is programmed or manually controlled to last for a certain period, after which time the heater and pump are switched off and no more hot water is delivered to the head portion 18. After a predetermined delay time, or when operated by a user, the solenoid 28 is de-energized so as to release the linkage frame 26 and the infusion basket 40, 40′ is then unclamped and released from its connection with the sealing flange 22. The infusion basket 40, 40′ rests on the U-shaped support 24 until ready to be removed by a user. As the seal is released, the infusion chamber 44, 44′ is depressurized and any remaining hot water in the head portion 18 and/or infusion basket 40, 40′ can drain out freely through the outlet 48, 48′. This can prevent liquid from being siphoned back into the appliance and prevent the user from being scalded by trapped hot water when removing the infusion basket 40, 40′.

The infusion basket 40, 40′ may also be vented at times during the infusion cycle, for example by controlling the current supplied to the solenoid 28 so as to temporarily or intermittently release the clamping force and allow air to enter the infusion chamber 44, 44′ past the seal 23. This may be used to control the pressure in the infusion basket 40, 40′.

An alternative method of de-pressurizing the infusion chamber 44, 44′ is to switch to a steam purge phase after the liquid dispensing phase. This may make it easier for a user to manually release the seal if a clamping mechanism is provided that is not automatically controlled by a solenoid.

In a third phase of operation the appliance reverts to producing steam, i.e. as in the first stage of operation. This stage of steam operation acts to flush any liquid which has been retained in the apparatus and not dispensed into the user's cup, i.e. in the outlet tube 16 and the head portion 18, thereby preventing this liquid which will subsequently cool from being dispensed in the next cycle of operation.

The appliance may be operated with only the first two stages of operation, i.e. producing steam to warm the dispensing components and then dispensing heated water. In this case, the first stage of producing steam for heating will also cause any liquid retained downstream of the boiling pool 12 to be ejected from the appliance prior to dispensing the beverage. The first phase may be made longer to account for this. Or only the second and third phases of operation may be employed, i.e. dispensing heated water and then de-pressurizing the infusion chamber using a steam purge phase. A further phase of hot water delivery, bypassing the infusion basket, may then follow—this will be described in more detail below.

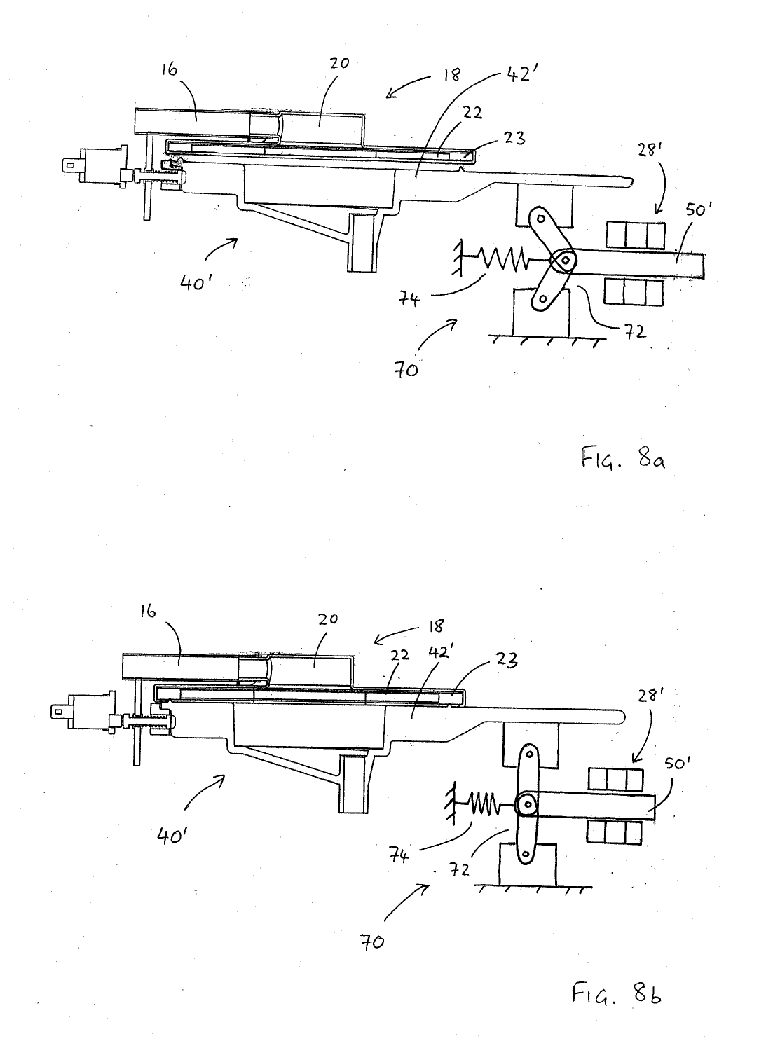

FIG. 8 depicts one example of an alternative clamping mechanism for an infusion basket 40′. Instead of a solenoid and linkage frame being provided on the head portion 18 over the delivery chamber 20, there is provided an electromagnetically operated clamping mechanism 70 that acts on the infusion basket 40′ from below. The mechanism 70 is only shown schematically in FIG. 8 and could still be provided by the head portion 18. This clamping mechanism 70 comprises a solenoid 28′ that operates a push rod 50′ acting on an over-center linkage 72. The over-center linkage 72 is shown in its unlocked position in FIG. 8a. A return spring 74 keeps the linkage 72 open in this position. As the solenoid 28′ is not energized, the infusion basket 40′ is supported below the sealing flange 22 of the head portion 18 but not sealed against it.

When the solenoid 28′ is energized, it pushes the rod 50′ against the force of the spring 74 to close the linkage 72, as is shown in FIG. 8b. The over-center mechanism applies a clamping force along its main vertical axis that is greater than the force applied by the solenoid 28′ to overcome the spring 74. The infusion basket 40′ is pushed up so as to bring its peripheral flange 42′ into contact with the seal 23 underneath the sealing flange 22 on the head portion 18. In this locked position the mechanism 70 acts to clamp the infusion basket 40′ against the head portion 18. When the infusion cycle is complete, the solenoid 28′ is released and the linkage 72 returns to its open position under the force of the spring 74. The infusion basket 40′ drops down from its sealed position and the pressure is released.

Although in FIG. 8 the clamping mechanism 70 is shown to be acting on the handle part of the infusion basket 40′, this is merely for ease of illustration and the mechanism 70 could act on any suitable part of the basket 40′. The clamping mechanism 70 may be arranged in a position such that it can operate on any infusion basket regardless of its size. Alternatively the clamping mechanism 70 could move or adapt to different infusion baskets.

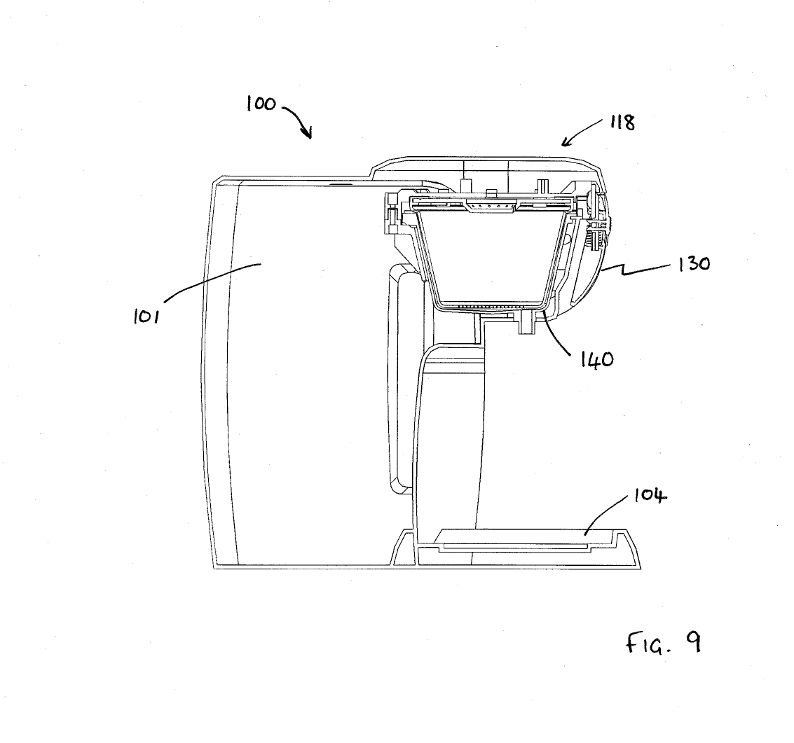

Turning to FIG. 9 there is seen another embodiment of an infusion beverage maker 100 comprising a main body 101 housing a water heater 102 (hidden from view) for delivering hot water and/or steam to a head portion 118 that has an infuser 140 connected thereto in use. The apparatus 100 includes a support 104 for a cup, carafe or other receptacle to receive an infused beverage. The support 104 may comprise a drip tray and/or warming plate. Although shown at the base, the support 104 may be in the form of a fold-down shelf, for example provided part way up the body 101 to support smaller receptacles such as cups. It can be seen from FIG. 9 that the apparatus 100 provides a manual clamping mechanism comprising a spring-loaded lever 130. This is an over-center mechanism for ease of operation. Connection of the infuser 140 to the head portion 118 will be described in more detail below.

Turning to FIG. 10, there is seen the flow heater 102 that supplies hot water and/or steam to the head portion 118. The flow heater 102 comprises a length of a sheathed immersion-type heating element 109 which, although not depicted, comprises an aluminum casing and a coiled resistance wire packed in magnesium oxide insulating powder. Arranged on and brazed to opposite sides of the heating element 109 are two aluminum water flow channels 108, 110. At one end of the heating element 109, two adjacent ends of the channels 108, 110 are connected together by means of a plastic U-tube 105 which is sealed onto the channels 108, 110 by clamps (not shown). This creates a circulatory flow path for water through the flow heater 102 from an inlet 106 to an outlet feeding into a closed heating chamber 112. The heating element 109 and the water flow channels 108, 110 conform closely to one another and are arranged in a J-shape, which allows a compact flow heater to be provided for fitting into a small appliance, e.g. a domestic kitchen coffee maker. This flow heater 102 is substantially horizontal whereas that described above has a vertical orientation.

The final heating chamber 112 is closed except for a single outlet leading to the head portion (at the back of the heater 102 and not seen in FIG. 10). However, in some embodiments the heating chamber 112 may also be provided with a steam release valve, for instance a one-way valve, to enable steam to be vented to atmosphere in the event of over-pressurization e.g. due to a blockage in the system. As is also seen from FIG. 11, the heating element 109 extends into the closed chamber 112 to heat a quantity of water retained therein and develop a steam pressure in the chamber 112. The main body 114 of the heating chamber 112 has an overall elongate rectangular shape in which the portion of the heating element 109 inside it occupies the lower portion, although water can pass all the way around it. A sideways extension houses the outlet (not seen) at the downstream end of the chamber 112. A weir may be provided inside the closed chamber 112 to retain a volume of water in contact with the heating element 109 upstream of the outlet.

A sealing flange 115 at the upstream end of the chamber body 114 provides a sealed entry for the heating element 109 and the upper flow channel 110 which project into the final heating chamber 112. The upper channel 110 terminates just inside the heating chamber 112, while the heating element 109 extends across the heating chamber 112 to project through the other side of the main body 114 where it is sealed at its cold tail 111. The cold tail 111′ at the other end of the heating element 109 is arranged to project clear of the channels 108, 110 near to the plastic connecting tube 105. This permits electrical connection to be made to the cold tails 111, 111′ at both ends of the heating element 109.

A bimetallic disc thermostat (also known as a half-inch disc)—not shown—may be clamped to one of the sides of the water flow channels 108, 110 and/or the heating element 109. In use, such a thermostat may be connected to a control circuit which can then provide power to or remove power from the heating element 109.

Although not shown in FIGS. 9 and 10, the flow heater 102 also comprises a cold water reservoir 150 fluidly connected to the inlet 106 of the lower channel 108 of the flow heater 102 via a pump 152, which are shown schematically in FIG. 11a. As is seen from the detail in FIG. 11b, the upper channel 110 of the flow heater 102 enters the closed chamber 112 together with the heating element 109. The heated chamber 112 comprises a weir 154 to hold a volume of water at its downstream side in contact with a heated portion 109a of the element. At the upstream side of the weir 154 the remaining portion 109b of the element is unheated. The weir 154 inside the heating chamber 112 acts to maintain a minimum water level inside the chamber 112. Since this minimum water level is above the heated portion of the heating element 109a, it may be ensured that during normal operation the heated portion 109a remains covered with water and cannot therefore overheat.

An expansion space 156 is provided in the chamber 112 above the liquid surface to allow for the escape of steam. Any steam bubbles generated in the liquid upstream of the chamber 112, i.e. in the flow tubes 108, 110, can be released here so that hot spots and film boiling are avoided. A particular benefit of the expansion space 156 in the closed chamber 112 is that a steam pressure will build up during a heating e.g. liquid dispensing phase. Once power is disconnected from the heating element 109, the steam pressure in the closed chamber 112 can force out any remaining liquid together with a burst of steam. Such a steam purge can be used to dry the components downstream of the heater 102 and release pressure in the infuser 140.

It is seen from the schematic system layout in FIG. 11a that downstream of the flow heater 102, e.g. in the head portion 118, a valve 128 can be provided to split the flow of hot water and/or steam between two separate paths. A solenoid valve is preferred. A normal flow path 131 delivers fluid into the infuser 140, while an alternative flow path 132 bypasses the infuser 140. The bypass path 132 may be used to deliver hot water into the same receptacle as receives infused beverage from the infuser 140, to dilute the beverage and adjust the intensity of flavor. Or the bypass path 132 may be used to deliver hot water separate to an infused beverage. Optionally a steam vent or vapor separator 134 is provided in the bypass 132 to remove any steam from the hot water before it is delivered.

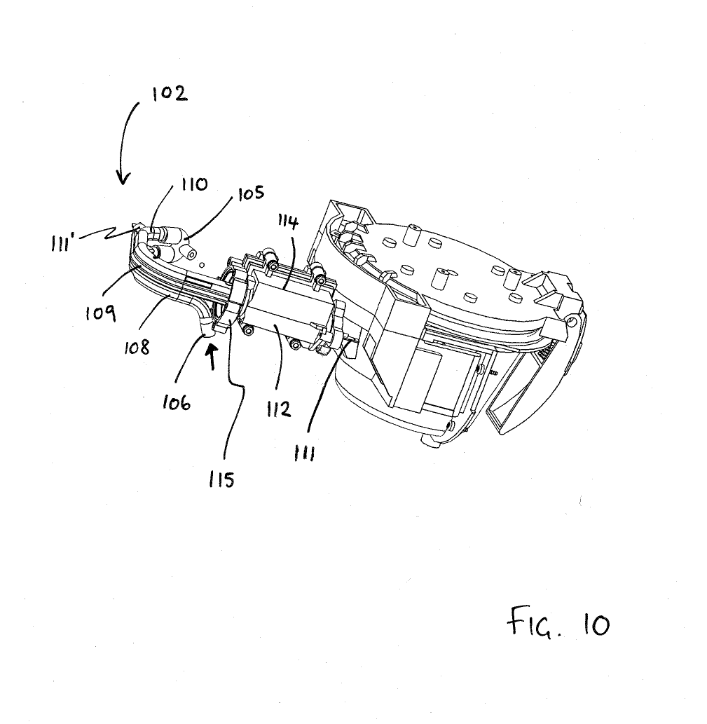

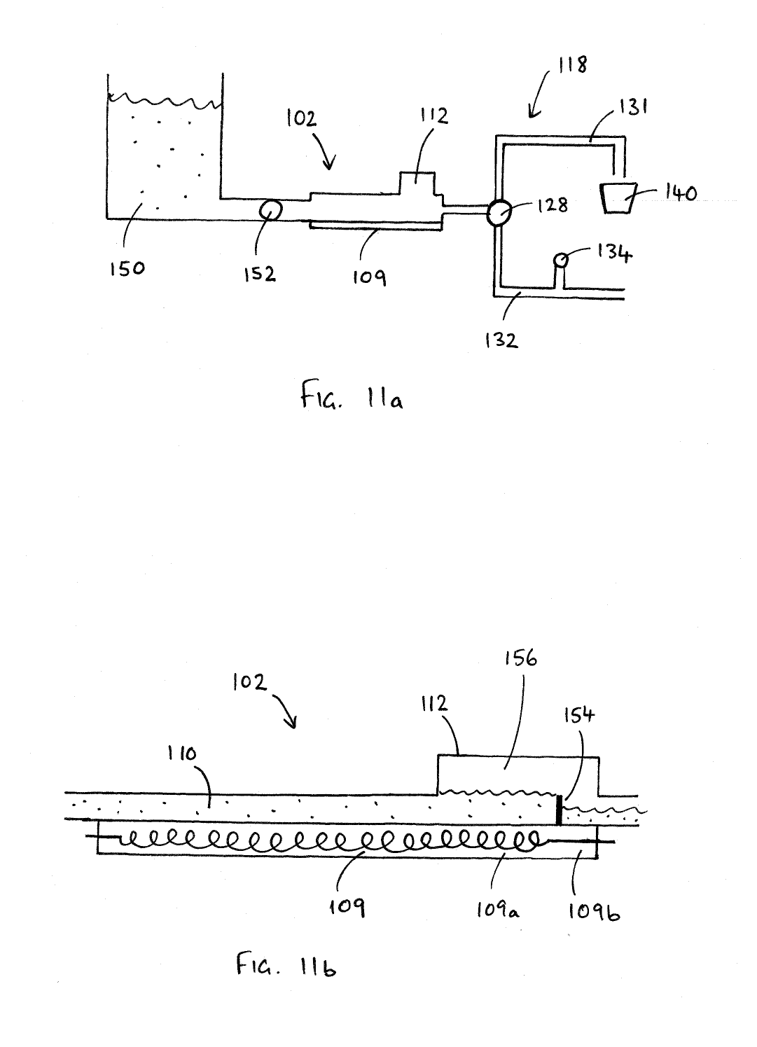

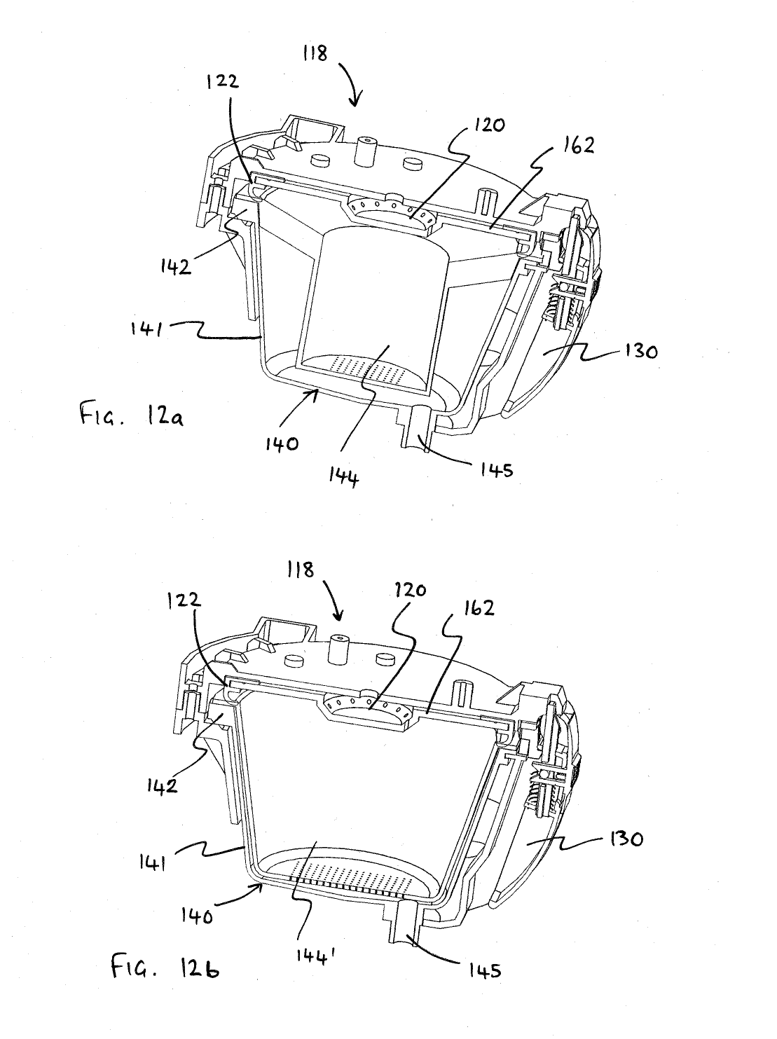

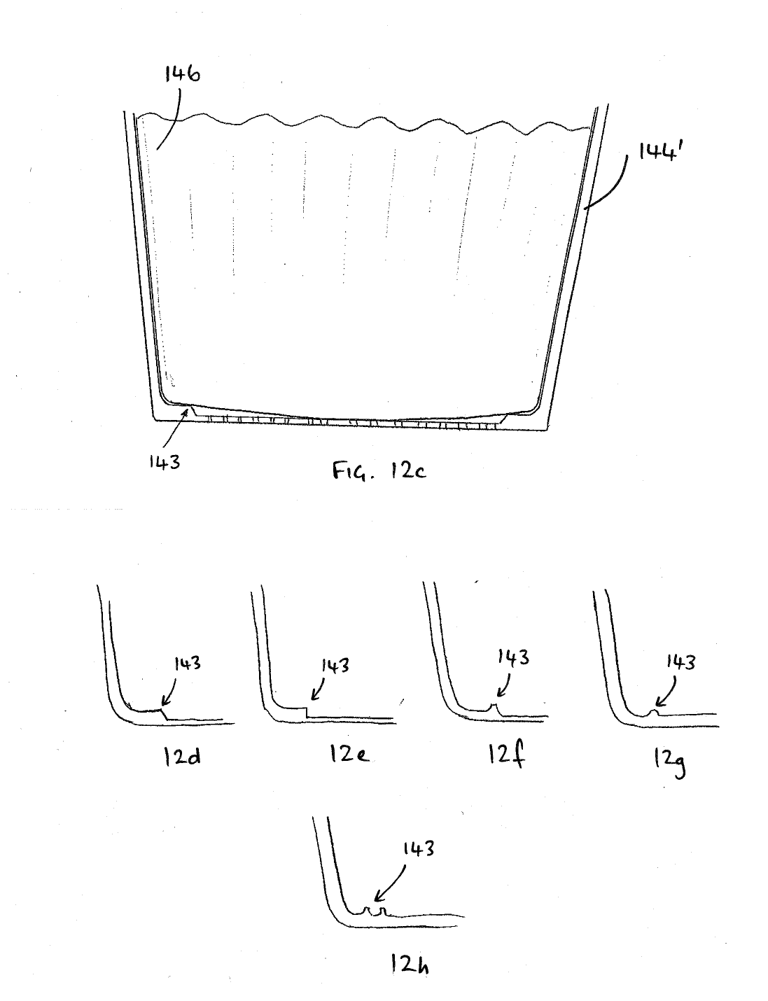

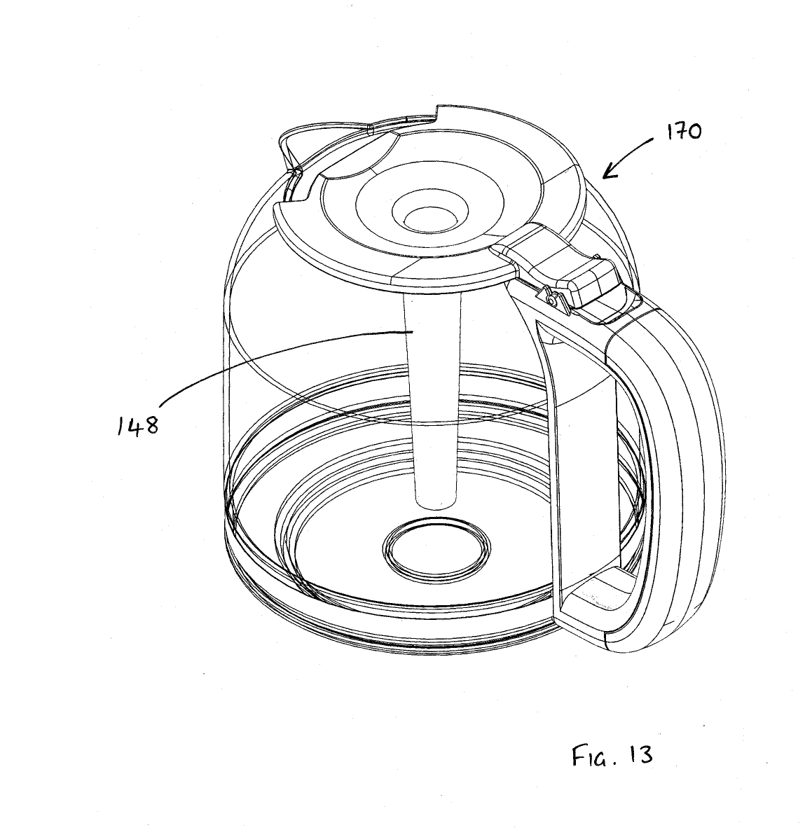

Heated liquid and/or steam passing through the normal flow path 131 is delivered into a distribution chamber 120 arranged in the top of the head portion 118, as is seen in FIGS. 12a and 12b. The distribution chamber 120 is defined by a perforated plate 162 that acts as a shower head to distribute water over a beverage material contained in the infuser 140 below. The perforated plate 162 is surrounded by a peripheral sealing flange 122 that forms the lowermost part of the head portion 118. In this apparatus the infuser 140 comprises an outer body 141 that is not normally removed from the head portion. The infuser body 141 has a peripheral flange 142 supported in the head portion 118 below the sealing flange 122. An infuser insert 144 is supported in the infuser 140, resting on the peripheral flange 142. When the lever 130 of the clamping mechanism is closed, the peripheral flange 142 of the infuser 140 is clamped against the sealing flange 122 of the head portion with a rim of the infuser insert 144 therebetween. The infuser 140 with its insert 144 therefore has a sealed connection with the head portion 118 so that a pressure above atmospheric pressure, e.g. 0.1 to 0.5 bar above atmospheric, can develop during use.

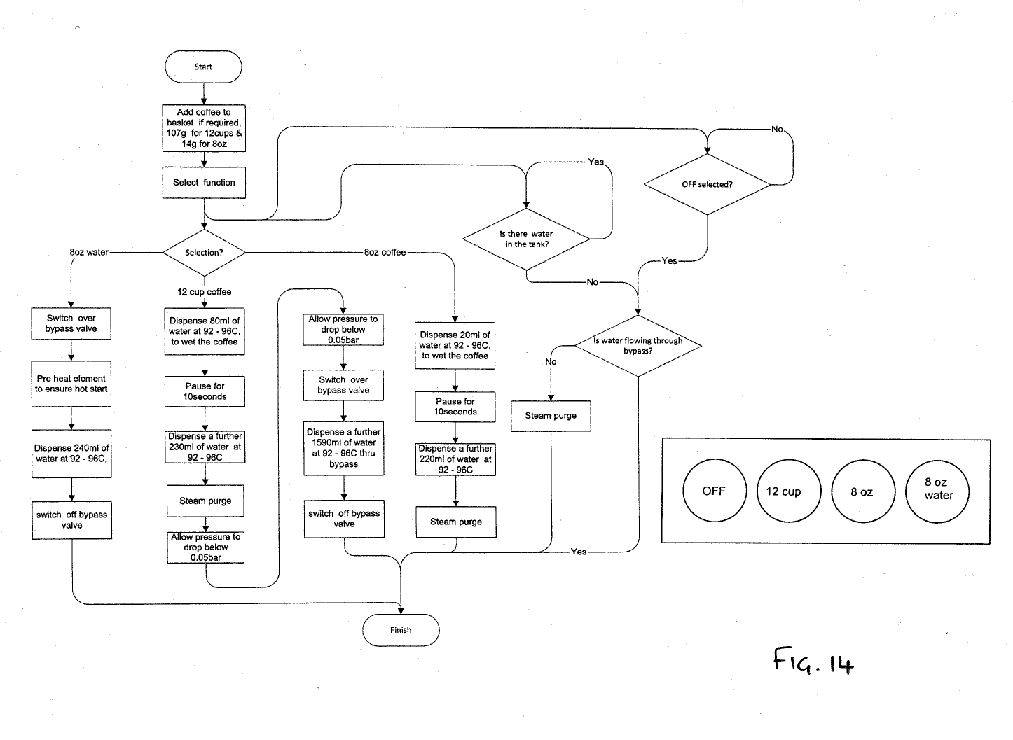

The infuser 140 is seen to have an outlet 145 for infused beverage in its base wall. While a single outlet 145 is shown, of course multiple outlets may be provided. The base of the infuser body 141 may even be perforated to provide a diffuse outflow. Although not show, the bypass path 132 may be fluidically connected to the outlet 145 so that additional hot water is mixed with the infused beverage as it exits the infuser 140. In an alternative arrangement illustrated by FIG. 13, both the outlet 145 from the infuser 140 and the bypass path 132 feed infused beverage and hot water, respectively, to a mixing channel 148 formed in the lid of a carafe 170 or other receptacle. The downwardly extending mixing channel 148 is formed of an opaque material e.g. molded plastic and allows the liquids to mix out of sight. During use a diluted beverage will be seen to exit from the bottom of the mixing channel 148 into the carafe 170.

In FIG. 12a there is seen an infuser insert 144 sized to hold a particular dose of beverage material e.g. suitable for a single cup serving. Different sized inserts 144 may be used depending on the amount of beverage material to be used. The insert 144 may be shaped to hold a pre-packaged permeable “pod” of beverage material. This gives a user flexibility to choose between using loose material such as coffee grounds or manufactured pods. The insert 144 is removable and interchangeable depending on the type of beverage material to be used and the desired beverage, in a similar way to the interchangeable infusion baskets 40, 40′ described above with respect to FIGS. 5 to 7. However an advantage of interchanging the insert 144 is that the outer body 141 of the infuser 140 can be reused and this can represent a material saving. Other insert designs will be readily apparent to those skilled in the art.

In FIG. 12b it is seen that the infuser insert 144′ has a volume and shape to match the interior of the infuser 140, which may have a generally truncated conical form. Such an insert 144′ can be used to prepare more than one cup of a beverage, for example to fill a 12 cup carafe, by filling it with a large dose of beverage material. However the same insert 144′ could also be used to make a single cup of beverage by reducing the dose. In both cases the same quantity of water may be pumped into the infuser 140 but, to fill the carafe, the beverage may be made up to volume by dispensing additional hot water directly via a bypass route after the infusion cycle. The infuser insert 144′ could be a single-use basket, for example pre-filled with beverage material and sealed by a removable cover. Or the infuser insert 144′ could be a single-use filter paper or a reusable e.g. plastic basket that a user fills with a dose of loose beverage material, either with or without a filter paper to catch any fines carried in the beverage.

When the infuser 140 is designed to be used with removable paper filter inserts 144′ or filter papers in an insert 144′, there can be a problem particularly if the paper filter has fluted side walls, as are often provided so that a filter is adaptable to different sizes of infuser. A disadvantage of a fluted filter paper is that hot water or partially infused beverage can escape through the side walls of the filter paper and down between the flutes to exit the infuser 140 without fully passing through the beverage solids contained therein. FIG. 12c and the partial details in FIGS. 12d-12h show how the insert 144′ of FIG. 12b may be provided with a barrier feature 143 on the inside of its base that contacts a filter paper 146 placed therein. The barrier feature 143 interrupts the flow of any liquid coming down the outside of the fluted side walls so that it is forced to pass back through the filter paper into contact with the beverage solids before filtering out from a more central position. The barrier feature 143 may be annular and is provided at a diameter which is less than the minimum diameter of the flutes in a typical filter paper but greater than the diameter of the outlet(s) in the insert 144′. Similarly, such a barrier feature may be provided directly on the inside of the body 141 of an infuser 140 where a filter paper may be used without a supporting insert 144, 144′. FIGS. 12d-h show various different cross-sectional forms for the barrier feature 143.

Operation of the beverage maker will now be described with reference to FIGS. 9 to 14. In order to remove and replace an infuser insert 144, 144′, the spring-loaded lever 130 is pushed upwards to release the clamping mechanism. This may be facilitated by first de-pressurizing the infuser 140 using a steam purge cycle as described above. When the peripheral flange 142 of the infuser 140 is no longer clamped against the peripheral seal 122 of the head portion 118, there is a gap between them allowing the insert 144, 144′ to be pulled out and replaced. The infuser 140 may even be used without an insert, for example a pod of beverage material placed directly inside and the infuser then clamped shut.

As is seen from FIG. 14, the apparatus has a user interface with an OFF button and buttons to start a function selected from “12 cup” e.g. to fill a carafe with infused beverage, “8 oz” e.g. for a serving of infused beverage, or “8 oz water” e.g. for a serving of hot water. A user loads an insert with beverage material or places a pod of beverage material in the infuser 140 and then manually operates the lever 130 to clamp the infuser 140 closed. After selecting the desired function, the beverage maker carries out one of the routines shown in FIG. 14. Initially the heating element 109 is activated to provide pre-heating and after a delay of typically five seconds (depending on the temperature of the water already in the heater) the pump 152 is operated to pump water from the cold water reservoir 150 to the flow heater 102. In other embodiments the pump 152 may be started before the heating element 109, or both could be started at same time.

To deliver hot water straightaway, the valve 128 is switched to enable water to flow out via the bypass path 132. The valve 128 is closed after the desired quantity of water has been dispensed. This may be followed by a beverage dispensing phase if desired.

To dispense a single 8 oz serving of an infused beverage, the apparatus first provides a pre-wetting phase in which a small volume e.g. 20 ml of hot water is dispensed into the infuser 140, followed by a pause e.g. of 10 s. The infusion phase is then commenced with the appropriate quantity of hot water e.g. 220 ml being passed through the infuser 140 to make the drink. After the liquid dispensing phase, a steam purge phase is provided by the steam pressure built up in the closed chamber 112 of the flow heater 109, which helps to de-pressurize the infuser 140 so that the lever 130 can then be moved to open the clamping mechanism.

To dispense a carafe of infused beverage, e.g. 12 cups of coffee, the apparatus first provides a pre-wetting phase in which a small volume e.g. 80 ml of hot water is dispensed into the infuser 140, followed by a pause e.g. of 10 s. A liquid dispensing phase is then carried out to pass sufficient hot water to optimally extract flavor from the beverage material in the infuser 140, for example 230 ml over one or two minutes. While the infusion phase is designed to optimally extract flavor from the beverage material, the resulting infusion will be too intense to drink and require dilution to make up the volume for a carafe. The infuser 140 is first purged using a steam dispensing phase to release the pressure e.g. to below 0.05 bar above atmospheric. After de-pressurization the solenoid valve 128 can be switched to provide further hot liquid via the bypass path 132 directly into the carafe, for example a further 1590 ml of water to make up a total volume of 2 liters. The bypass valve 28 is switched back to its default state at the end of the process.

It will be appreciated that the various operational modes or phases shown in FIG. 13 may not necessarily be run in the order shown in these example routines. For instance, a steam purge phase may be added at the beginning of a routine to dry and pre-warm the apparatus, instead of or as well as a steam purge phase after the liquid dispensing phase. The dispensing phase may not be continuous but could be pulsed with several dispensing phases separated by a pause and/or steam purge phase. A bypass dispensing phase may also be added at the end of a routine for dispensing a single serving (e.g. 8 oz coffee), for example when a user indicates that a weaker beverage is desired. Additional routines may of course be run with volumes and dispensing periods adjusted for a particular beverage. As well as (or instead of) the program buttons, an interface may be provided that allows a user to select the different parameters of a dispensing cycle, e.g. including infusion time, beverage volume, bypass water volume, etc.

It will further be appreciated by those skilled in the art that many variations and modifications to the embodiments described above may be made within the scope of the various aspects of the invention set out herein. For example, the beverage makers described above may be used with a variety of different infusion baskets or infusers, with or without removable inserts. Suitable infusion baskets and infusers are not limited to the shape or form shown in the illustrated embodiments but may vary considerably while still providing the same outer peripheral flange corresponding to the sealing flange on the head portion. The beverage maker may also vary in the form of its sealing flange and this will affect the corresponding flange provided on infusion baskets or infusers designed to be connected thereto.

What is claimed is:

1-32. (canceled)

31. An infusion beverage making apparatus comprising a liquid flow heater, an infusion means for receiving beverage solids and allowing an infused beverage to be obtained therefrom, and conveying means comprising a pump to convey liquid through the heater and to the infusion means, and a valve downstream of the heater to control the delivery of liquid to the infusion means, wherein the apparatus is arranged to first operate in a liquid dispensing mode in which the heater is operated to heat liquid and heated liquid is pumped into the infusion means, followed by a steam purging mode in which steam is passed into the infusion means to contact the beverage solids therein, and subsequently in a bypass mode in which the valve switches the delivery of liquid to a path bypassing the beverage solids.

32. An apparatus as claimed in claim 31, wherein the infusion means is pressurized in the liquid dispensing mode to a pressure between 0.1 and 0.5 bar above atmospheric pressure.

33. An apparatus as claimed in claim 31, wherein the steam purging mode reduces the pressure in the infusion means to 0.05 bar, or less, above atmospheric pressure.

34. An apparatus as claimed in claim 31, further arranged to operate in an initial mode in which a volume of liquid is pumped into the infusion means, followed by a pause, before entering the liquid dispensing mode.

35. An apparatus as claimed in claim 31, arranged to convey a first volume of heated liquid from the heater to the beverage solids and then, after a predetermined delay, to convey a second, greater, volume of heated liquid to pass through the beverage solids.

36-65. (canceled)

66. A method of operating an infusion beverage maker comprising a liquid flow heater, an infusion means for receiving beverage solids and allowing an infused beverage to be obtained therefrom, and conveying means comprising a pump to convey liquid through the heater and to the infusion means, and a valve downstream of the heater to control the delivery of liquid to the infusion means, comprising:
operating the heater and pump to heat liquid and convey the heated liquid into the infusion means in a liquid dispensing mode;
passing steam into the infusion means to contact the beverage solids in a steam purging mode; and
subsequently switching the valve so as to deliver heated liquid to a path bypassing the beverage solids in a bypass mode.

67-69. (canceled)
